(19) United States
(12) Patent Application Publication
(10) Pub. No.: US 2025/0277935 A1
(43) Pub. Date: Sep. 4, 2025

(54) MANAGING MODULE INTERFACES FOR MODULAR OPTICAL SYSTEMS

(71) Applicant: Analog Photonics LLC, Boston, MA (US)

(72) Inventors: Michael Robert Watts, Hingham, MA (US); Jonathan Andrew Guglielmon, Cambridge, MA (US); Shengjie Xie, Brighton, MA (US); Benjamin Roy Moss, Cambridge, MA (US); Michael J. Nickerson, Boston, MA (US)

(73) Assignee: Analog Photonics LLC, Boston, MA (US)

(21) Appl. No.: 19/063,036

(22) Filed: Feb. 25, 2025

Related U.S. Application Data
(60) Provisional application No. 63/559,417, filed on Feb. 29, 2024.

(51) Int. Cl. G02B 6/124; G02B 6/122

(52) U.S. Cl. CPC G02B 6/124; G02B 6/1228

(57) ABSTRACT

A first (second) chip comprises a first (second) surface in proximity to a first (second) set of two or more waveguide couplers. The chips are optically coupled to each other by an interface between the surfaces in which: a first waveguide coupler of the first set is in proximity to a second waveguide coupler of the second set within a distance that supports evanescent optical coupling between the first waveguide coupler and the second waveguide coupler that are overlapped within a first coupling region, and a third waveguide coupler of the first set is in proximity to a fourth waveguide coupler of the second set within a distance that supports evanescent optical coupling between the third waveguide coupler and the fourth waveguide coupler that are overlapped within a second coupling region.

### CROSS-REFERENCE TO RELATED APPLICATION(S)

This application claims the benefit of and priority to U.S. Provisional Application Ser. No. 63/559,417, entitled “MANAGING MODULE INTERFACES FOR MODULAR OPTICAL SYSTEMS,” filed Feb. 29, 2024, which is incorporated herein by reference.

### TECHNICAL FIELD

This disclosure relates to managing module interfaces for modular optical systems.

### BACKGROUND

Chip-scale devices and systems comprising integrated circuits have applications ranging from electronics to optical connectivity. Some integrated circuit devices are configured to guide or manipulate optical waves using photonic components or subcomponents. Such integrated circuit devices can be referred to as photonic integrated circuits or PICs. Some PICS comprise “active” components that are configured to receive power, such as a voltage or current, from external circuitry. Some PICs comprise “passive” components that are configured to guide or direct optical waves or photonic signals without power from external circuitry. Some PICs are configured as passive photonics chips such that at least a portion of the passive photonics chip comprises components that do not use power from external circuitry.

In some examples, PICs comprising active and passive components can be used for light detection and ranging (LiDAR) systems, where an optical wave from an optical source can be transmitted to target object(s) at a given distance and the light backscattered from the target object(s) can be collected. Various techniques, such as modulation and/or time of flight, can be used to determine distance to a target object based on information associated with a detection event.

The functionality of some photonic microsystems or PICs can be sensitive to the precise performance of very specific subcomponents. In many cases, suboptimal performance of a subcomponent is tolerated to facilitate integration of the subcomponents into a unified fabrication process flow with other components. For example, the loss of nitride waveguides can be improved through high-temperature annealing; however, annealing may be incompatible with doped active components, so often higher nitride waveguide loss is tolerated to facilitate its inclusion in an active process.

The optical source used in such photonic systems can be a laser or other coherent light source, which enables photonic signals to be carried on an optical wave that has as narrow linewidth and has a peak wavelength that falls in a particular range (e.g., between about 100 nm to about 1 mm, or some subrange thereof), also referred to herein as simply “light.”

### SUMMARY

In one aspect, in general, an apparatus comprises: a first chip comprising a first surface in proximity to a first set of two or more waveguide couplers; and a second chip comprising a second surface in proximity to a second set of two or more waveguide couplers; wherein the first chip and the second chip are optically coupled to each other by an interface between the first surface and the second surface in which: a first waveguide coupler of the first set of two or more waveguide couplers is in proximity to a second waveguide coupler of the second set of two or more waveguide couplers within a distance that supports evanescent optical coupling between the first waveguide coupler and the second waveguide coupler that are overlapped within a first coupling region, a third waveguide coupler of the first set of two or more waveguide couplers is in proximity to a fourth waveguide coupler of the second set of two or more waveguide couplers within a distance that supports evanescent optical coupling between the third waveguide coupler and the fourth waveguide coupler that are overlapped within a second coupling region, and the first coupling region is separated from the second coupling region by a separation distance that is larger than a maximum length of the first coupling region and larger than a maximum length of the second coupling region.

Aspects can include one or more of the following features.

Each waveguide coupler in the first set of two or more waveguide couplers is at an end of a corresponding waveguide on first chip, and each waveguide coupler in the second set of two or more waveguide couplers is at an end of a corresponding waveguide on the second chip.

The corresponding waveguides on the first chip are arranged (1) to have propagation axes that are all parallel to a common axis and (2) such that corresponding waveguide couplers of waveguides that are adjacent to each other on the first chip are offset from each other along the common axis.

The first waveguide coupler and the third waveguide coupler are substantially coplanar with a first plane that is parallel to the common axis and the second waveguide coupler and the fourth waveguide coupler are substantially coplanar with a second plane that is parallel to each of the common axis and the first plane.

A portion of the first waveguide coupler and a portion of the second waveguide coupler within the first coupling region are contained within a third plane that is perpendicular to the first plane and perpendicular to the common axis, and a portion of the third waveguide coupler and a portion of the fourth waveguide coupler within the second coupling region are contained within a fourth plane that is perpendicular to the first plane and perpendicular to the common axis.

The third plane and the fourth plane are distributed along the common axis.

Each of the first waveguide coupler, the second waveguide coupler, the third waveguide coupler, and the fourth waveguide coupler comprise respective grating couplers.

Each waveguide coupler of the first set of two or more waveguide couplers is optically coupled to a different respective optical phase shifter.

Each waveguide coupler of the second set of two or more waveguide couplers is optically coupled to a different respective optical antenna.

The first surface of the first chip is in proximity to a third set of one or more waveguide couplers and the second surface of the second chip is in proximity to a fourth set of one or more waveguide couplers.

The first chip and the second chip are optically coupled to each other by a second interface between the first surface and the second surface in which: a fifth waveguide coupler of the third set of one or more waveguide couplers is in proximity to a sixth waveguide coupler of the fourth set of one or more waveguide couplers within a distance that supports evanescent optical coupling between the fifth waveguide coupler and the sixth waveguide coupler that are overlapped within a third coupling region.

At least one waveguide coupler in the fourth set of one or more waveguide couplers is in optical communication with an optical source on the second chip.

In another aspect, in general, an apparatus comprises: a first chip comprising a first surface in proximity to a first set of two or more waveguide couplers; and a second chip comprising a second surface in proximity to a second set of two or more waveguide couplers; wherein the first chip and the second chip are optically coupled to each other by an interface between the first surface and the second surface in which: a first waveguide coupler of the first set of two or more waveguide couplers is in proximity to a second waveguide coupler of the second set of two or more waveguide couplers within a distance that supports evanescent optical coupling between the first waveguide coupler and the second waveguide coupler that are overlapped within a first coupling region, a third waveguide coupler of the first set of two or more waveguide couplers is in proximity to a fourth waveguide coupler of the second set of two or more waveguide couplers within a distance that supports evanescent optical coupling between the third waveguide coupler and the fourth waveguide coupler that are overlapped within a second coupling region, the first waveguide coupler and the third waveguide coupler are each at an end of a waveguide that is coupled to an active photonic component, and the second waveguide coupler and the fourth waveguide coupler are each at an end of a waveguide that is coupled to a passive photonic component.

Aspects can include one or more of the following features.

The active photonic component comprises an optical phase shifter.

The first chip comprises one or more through oxide vias in electrical communication with the active photonic component.

The passive photonic component comprises an optical antenna.

Each of the first waveguide coupler and the second waveguide coupler comprise a respective adiabatic taper within the first coupling region, and each of the third waveguide coupler and the fourth waveguide coupler comprise a respective adiabatic taper within the second coupling region.

The first waveguide coupler comprises a first adiabatic taper and a second adiabatic taper within the first coupling region, wherein the first adiabatic taper has a first cross section and the second adiabatic taper has a second cross section that is different than the first cross section.

In another aspect, in general, an apparatus comprises: a first chip comprising (1) a first surface in proximity to a first set of two or more waveguide couplers, and (2) a set of two or more optical phase shifters coupled to the first set of two or more waveguide couplers; a second chip comprising (1) a second surface in proximity to a second set of two or more waveguide couplers, and (2) a set of two or more optical antennas coupled to the second set of two or more waveguide couplers; and a controller to control respective phase shifts of the optical phase shifters to transmit and/or receive an optical beam using an optical phased array comprising the two or more optical antennas; wherein the first chip and the second chip are optically coupled to each other by an interface between the first surface and the second surface in which: a first waveguide coupler of the first set of two or more waveguide couplers is in proximity to a second waveguide coupler of the second set of two or more waveguide couplers within a distance that supports evanescent optical coupling between the first waveguide coupler and the second waveguide coupler that are overlapped within a first coupling region, and a third waveguide coupler of the first set of two or more waveguide couplers is in proximity to a fourth waveguide coupler of the second set of two or more waveguide couplers within a distance that supports evanescent optical coupling between the third waveguide coupler and the fourth waveguide coupler that are overlapped within a second coupling region.

Aspects can include one or more of the following features.

The second chip further comprises (3) at least one optical distribution network coupled to a third set of two or more waveguide couplers.

The first chip and the second chip are optically coupled to each other by an interface between the first surface and the second surface in which each waveguide coupler of the first set of two or more waveguide couplers is in proximity to a different respective waveguide coupler of the second set of two or more waveguide couplers within a distance that supports evanescent optical coupling between the each waveguide coupler of the first set of two or more waveguide couplers and the different respective waveguide coupler of the second set of two or more waveguide couplers within a distance that supports evanescent optical coupling between the each waveguide coupler and the different respective waveguide coupler that are overlapped within a respective coupling region.

The interface between the first surface and the second surface is configured to suppress crosstalk between adjacent coupling regions.

Adjacent coupling regions are separated from each other by a separation distance that is larger than a maximum length of each of the coupling regions of the adjacent coupling regions.

Each coupling region is offset from an adjacent coupling region along a respective propagation axis associated with an optical wave traveling through the coupling region.

Aspects can have one or more of the following advantages.

High-density optical chip-to-chip interfaces are provided to enable modular packaging and assembly, resulting in a performance gain and cost reduction in silicon photonic microsystems. The potential cost penalties from over-integration can be mitigated through modular packaging and assembly flows. A silicon photonic circuit constructed using an active process, yet area-dominated by passive components, can be cost-inefficient. In some implementations, a two-chip solution can allow the performance of the active photonics to be optimized separately from the passive process, yielding performance gains in both if the modular packaging and assembly flow carries a low loss penalty and is high-density. The high cost-per-area of the active subcircuit can be reduced to the area solely required, and the remainder of the low cost-per-area passive circuit can result in a net cost reduction of the microsystem.

Some implementations of modular packaging and assembly can enable the performance of photonic systems with complementary metal-oxide-semiconductor (CMOS) integration to be optimized with lower cost. CMOS process improvement is rapid, with new process nodes available from foundries every two to three years. Depending on the microsystem requirements, a CMOS process suitable for an application requiring high-speed digital computation may be a poor choice for another application requiring high-voltage control. Modular packaging and assembly can allow any optimal CMOS process to be arbitrarily integrated with silicon photonics, and in such a way that reduced CMOS area is used to avoid detrimental wasted area on expensive silicon.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1-5 are schematic diagrams of example assembled systems.

FIGS. 6A-6J are schematic diagrams of stages of an example fabrication process flow.

FIGS. 7A-9B are schematic diagrams of example couplers.

FIGS. 10A-10B, and 11 are schematic diagrams of example coupler arrays.

FIGS. 12A-12B are schematic diagrams of an example coupler comprising gratings.

FIG. 13 is a schematic diagram of an example coupler array.

FIG. 14A is a schematic diagram of an example device.

FIGS. 14B-14M are schematic diagrams of stages of an example fabrication process flow.

### DETAILED DESCRIPTION

Included herein are a variety of examples of techniques for modular packaging and assembly, including an overall processing flow that can be used to form the assembled chips. Some implementations integrate passive and active photonic chips with CMOS chips in a way that enables high-density optical coupling between chips and cost-efficient use of photonic fabrication processes. As referred to herein, a “chip” may refer to an entire wafer or a portion of a wafer, such as a die formed from a wafer that has been diced into multiple dies (also referred to as chiplets). These chips utilize photonic interconnects that allow light to be routed between the active and passive photonic-coupled chips. A variety of examples of these high-density photonic chip-to-chip interconnects are described.

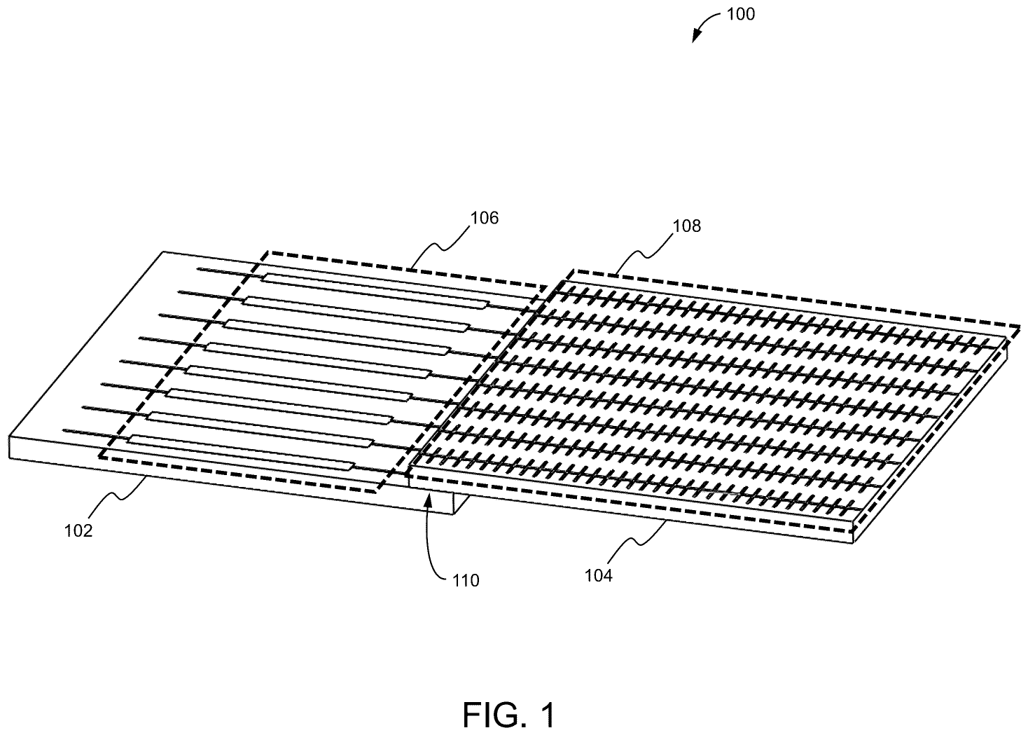

FIG. 1 shows an example device 100 comprising a modular packaging scheme for an optical phased array (OPA). The device 100 comprises an active PIC 102 bonded to a passive PIC 104. In some examples, the active PIC 102 can be configured to transmit or receive coherent optical signals. The active PIC 102 comprises a first surface in proximity to a set of waveguide couplers (not shown) that are coupled to optical phase shifters 106. The passive PIC 104 comprises a second surface in proximity to a set of waveguide couplers (not shown) that are coupled to an array of optical grating antennas 108. The active PIC 102 and the passive PIC 104 are optically coupled to each other by an optical coupler region 110 between the first surface of active PIC 102 and the second surface of the passive PIC 104. The optical coupler region 110 comprises the waveguide couplers of the active PIC 102 and the waveguide couplers of passive PIC 104. In some implementations, these the waveguide couplers can be referred to as optical interconnects and can be high-density such that the optical interconnects comprise a pitch of approximately 1 μm.

In some examples, modular design can offer several advantages in chip production by enabling the use of different process nodes for the passive and active PICs. High-temperature annealing, which can be incompatible with active chip doping, can be applied to passive chips, thereby reducing losses in waveguides and minimizing phase defects that impair beam quality. Active chips, which can be more expensive per unit area, can benefit from cost savings by minimizing their usage in routing areas and focusing them on critical functionalities. Additionally, limitations in reticle size can be mitigated, allowing more area to be dedicated to emitters, which can enhance beam directivity. The modular approach can support reconfigurability and can enable the same active photonic integrated circuit (PIC) to accommodate interchangeable grating antenna designs. Subcomponents can also be pre-yielded before bonding, which can improve overall manufacturing efficiency. Evanescent coupling with mechanical references can relax vertical alignment constraints, and high-density optical coupling can help reduce the formation of grating lobes, which can further enhance system performance.

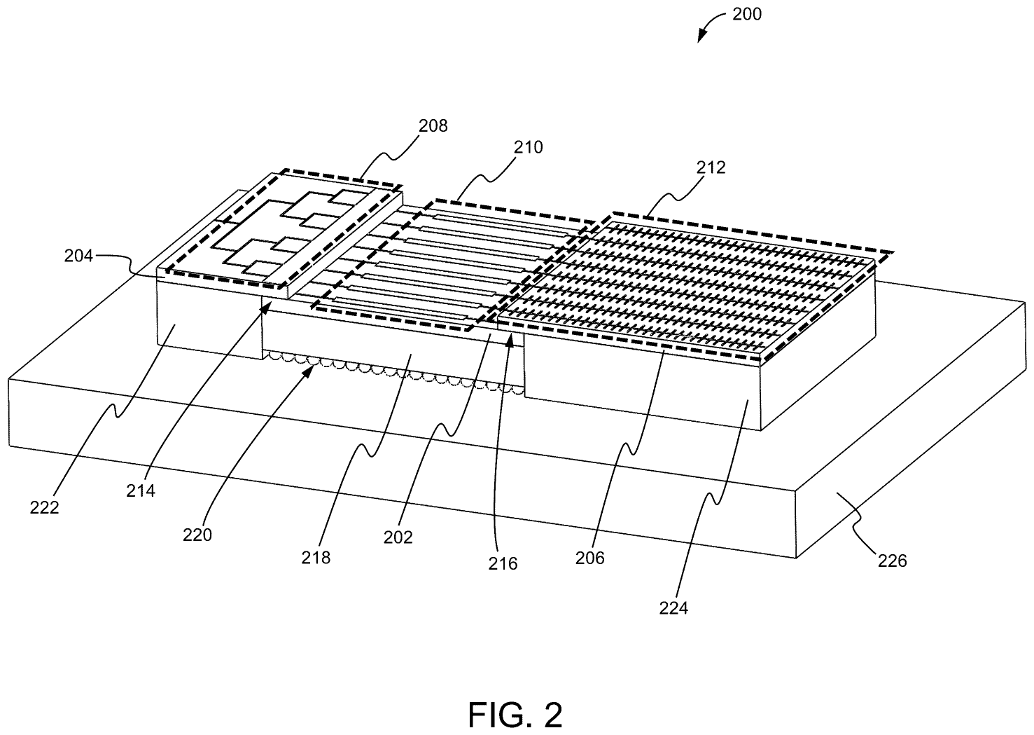

FIG. 2 depicts an example device 200 comprising a modular packaging scheme. The device 200 comprises an active PIC 202 that is bonded to two passive PICs 204, 206. In some implementations, this configuration can enable the transmission or reception of coherent optical signals. The passive PIC 204 includes an optical distribution network 208 that is configured to split a coherent optical input into multiple spatially separated channels. The active PIC 202 comprises an array of optical phase shifters 210, while the passive PIC 206 comprises an array of optical grating antennas 212. Optical coupler region 214 interconnects the active PIC 202 and the passive PIC 204 while optical coupler region 216 interconnects the active PIC 202 and the passive PIC 206. In some examples, the optical coupler regions 214, 216 can each comprise high-density optical couplers with approximately 1 μm pitch providing optical interconnects between these components. The active PIC 202 is bonded to a CMOS chip 218, which can be configured to manage the array of optical phase shifters 210. In some examples, the array of optical phase shifters 210 can be configured as a high-density array of phase shifters. The CMOS chip 218 comprises through-silicon vias (TSVs, not shown) to route electrical power and control signals to a ball grid array (BGA) 220. In some examples, routing electrical power and control signals can place components of a device in electrical communication with each other. The passive PIC 204 and the passive PIC 206 are each mounted to respective supports 222, 224. In some examples, the supports 222, 224 can provide mechanical stability. The entire assembly is integrated with a printed circuit board (PCB) or substrate 226.

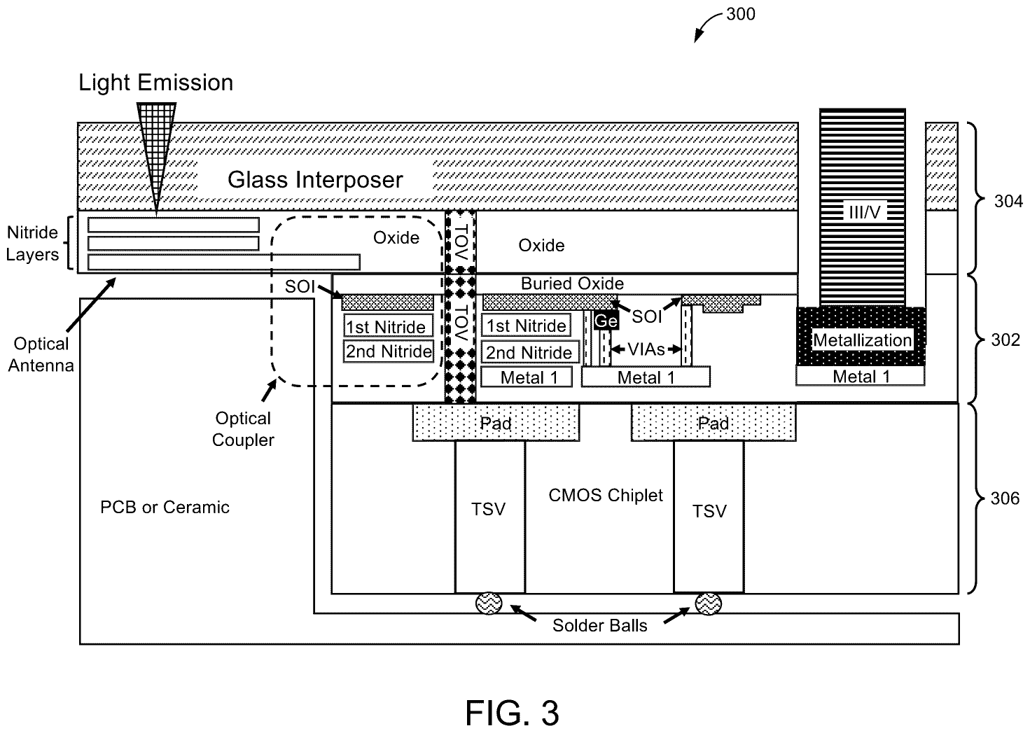

FIG. 3 shows a cross-section view of a device 300 that can be used as a LiDAR system. In some implementations, the device 300 can be configured using modular packaging and assembly flow. The device 300 comprises (1) active photonic components (such as phase shifters and/or photodiodes) on an active chip 302 and (2) a large region acting as one or more transmit/receive apertures that include only passive components (e.g., optical antennas, and/or optical splitter trees) on a passive chip 304. In some examples, the active chip 302 can be referred to as an “active photonic chip” and the passive chip 304 can be referred to as a “passive photonic chip.” A variety of other types of active and passive photonic-coupled chips (including processors or other active electronic chips that use photonic signals that are converted to/from electronic signals when coupling to the electronic circuitry) can be coupled together using the photonic interface. Fabricating both the active and passive components using a single process can be inefficient due to the large area occupied by the transmit/receive apertures which do not make use of the active components available in the process. The packaging process illustrated in FIG. 3 can address this inefficiency by making use of a separately fabricated passive chip 304 and active chip 302. For example, the active chip 302 can comprise a photonic wafer that can be fabricated using an active process which implements the active components used by the system. The active chip 302 comprises layers such as metals, doped silicon, and Germanium. The active chip 302 also comprises through oxide vias (TOV) which allow for electrical connections to be made to a CMOS chiplet 306. The active chip 302 is then bonded on the wafer scale to the passive chip 304. The CMOS chiplet 306 comprises components such as DACs and ADCs that interface with the active silicon photonic components. The CMOS chiplet 306 also comprises through silicon vias (TSV) that can allow electrical connections to pass through the CMOS chiplet 306. In some examples, a hybrid active-photonic-CMOS wafer can formed by bonding an active chip to a CMOS wafter and then dicing the wafer to yield chiplet containing an active chip bonded to a CMOS chip. In some examples, the passive chip 304 can be formed from a separate passive wafer and can comprise passive photonic components required by the system, such as transmit and receive apertures for an optical phased array LiDAR system. The passive wafer can undergo processing, including replacement of the handle wafer with a glass wafer (discussed below), and can then be diced into chips, and bonded on the chip scale to the surface of the active photonic chip. In some examples, the bond surface can be confined to a region and does not need to cover the full surface of the chips. As discussed in more detail below, optical couplers can allow light to be passed between the active chip 302 and the passive chip 304. As shown in FIG. 3, the CMOS chiplet 306 can be attached to a substrate, such as a PCB or ceramic substrate. The TSVs on the CMOS chiplet 306 can be electrically connected to pads on the substrate (e.g., using solder balls). This connection can allow components on the CMOS chiplet 306 to interface electrically with components on the substrate. Further, since the TSVs connect up to the photonic components, they can also provide a path for the photonic components to connect electrically to the PCB/substrate. The TOVs on the active chip 302 can allow electrical connection to be made to the CMOS chiplet 306 and also up to the passive photonic components if needed. To allow for the integration of gain media that can be used for lasers and optical amplifiers, a trench can be etched through the passive chip 304 and into the active chip 302, the trench can be metallized, and III/V materials can be flipped into the trench, as illustrated in FIG. 3. In some examples, the trench can be etched only through an active chip if the passive chip is not present in the region where the trench is being etched. More details about the process flow used to implement the above packaging process are discussed below.

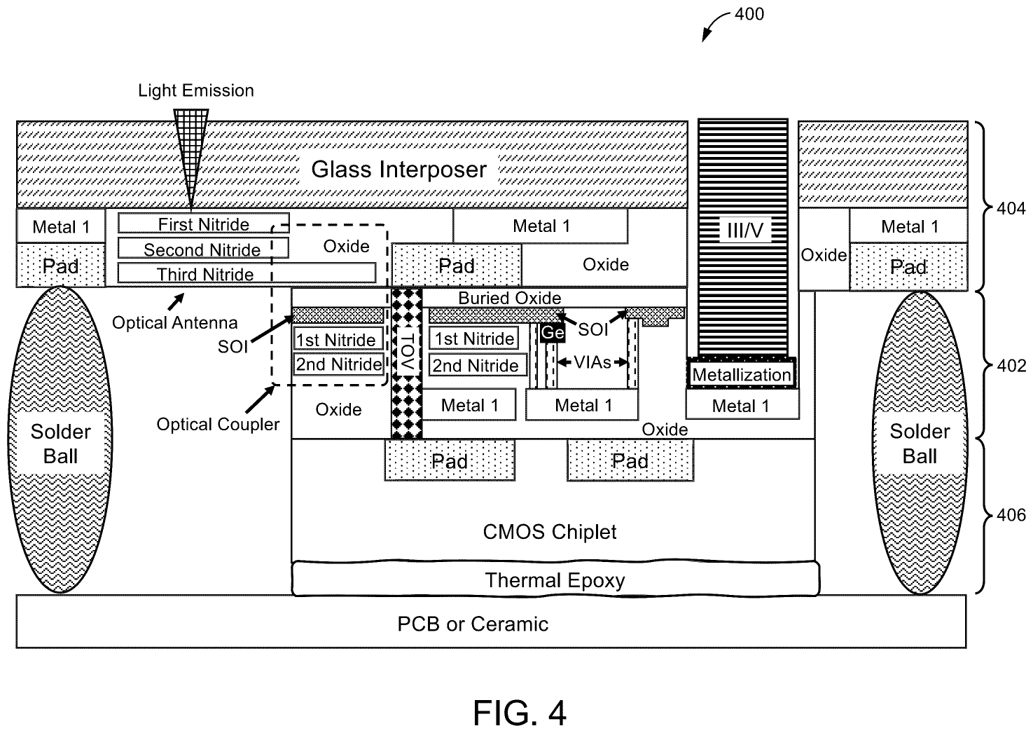

FIG. 4 shows a cross-section view of a device 400 that is produced using a packaging process similar to the one described above. The device 400 comprises an active photonic chip 402, a passive photonic chip 404, and a CMOS chiplet 406. The CMOS chiplet 406 of the device 400 does not include TSVs. Instead, metal layers are included in the passive photonic chip 404 so that electrical connections from the CMOS chiplet 406 and active photonic chip 402 can be routed up to the metals in the passive photonic chip 404 using the TOVs for connections originating from the CMOS chiplet 406. The connections can then routed to pads located on the passive photonic chip 404 which are then electrically connected to a PCB/ceramic substrate using, for example, solder balls. In this process, the CMOS chiplet 406 is attached to the substrate using an adhesive such as an epoxy.

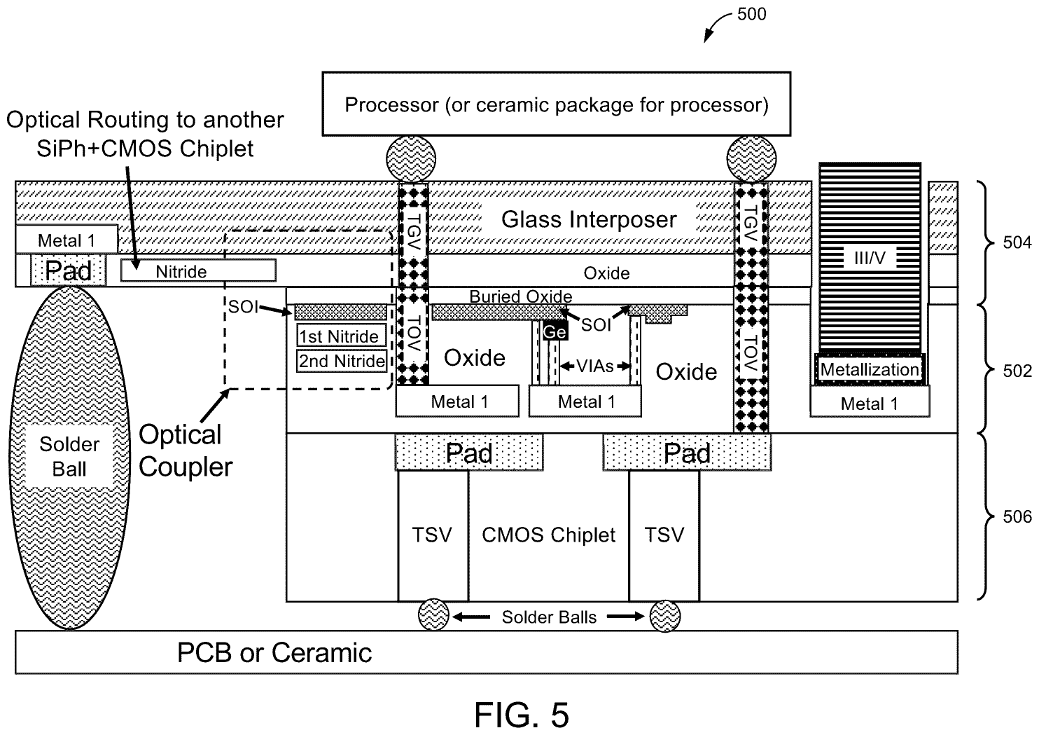

FIG. 5 shows a cross-section view of an example device 500 formed from a modular packaging process applied to enable high-density chip-to-chip optical interconnects that interface with a processor. The device 500 comprises an active photonic chip 502, a passive photonic chip 504, and a CMOS chiplet 506. As in the processes discussed earlier, a CMOS wafer and active photonic wafer can be bonded on the wafer scale and then diced into hybrid active-photonic- CMOS chip comprising the active photonic chip 502 and the CMOS chiplet 506. This hybrid active-photonic-CMOS chip can then bonded on the chip scale to a passive photonic chip 504 fabricated with a separate process. In this example, the passive photonic chip 504 contains through glass vias (TGV) that allow electrical connections to be made to a processor residing above the passive photonic chip 504. The active photonic chip 502 comprises TOVs which allow electrical connections to pass through the active photonics chip, and the CMOS chiplet 506 comprises TSVs that allow connections to pass through the CMOS chiplet 506 to a PCB/ceramic substrate. Using the TGVs and the TOVs, the processor can transfer data electrically to the CMOS chiplet 506, which can then drive the active components on the active photonic chip 502. By driving the components on the active photonic chip 502, e.g., modulators connected to laser source(s), data can be encoded in an optical signal that can then be routed from the active photonic chip 502 up to the passive photonic chip 504 using optical couplers that are described in more detail below. Light can then be routed through the passive photonic chip 504 to a region that is bonded to a second active-photonic-CMOS hybrid chip (not shown), which can be possibly connected to another processor. The light can be coupled to the second hybrid chip using the optical couplers that are discussed in more detail below.

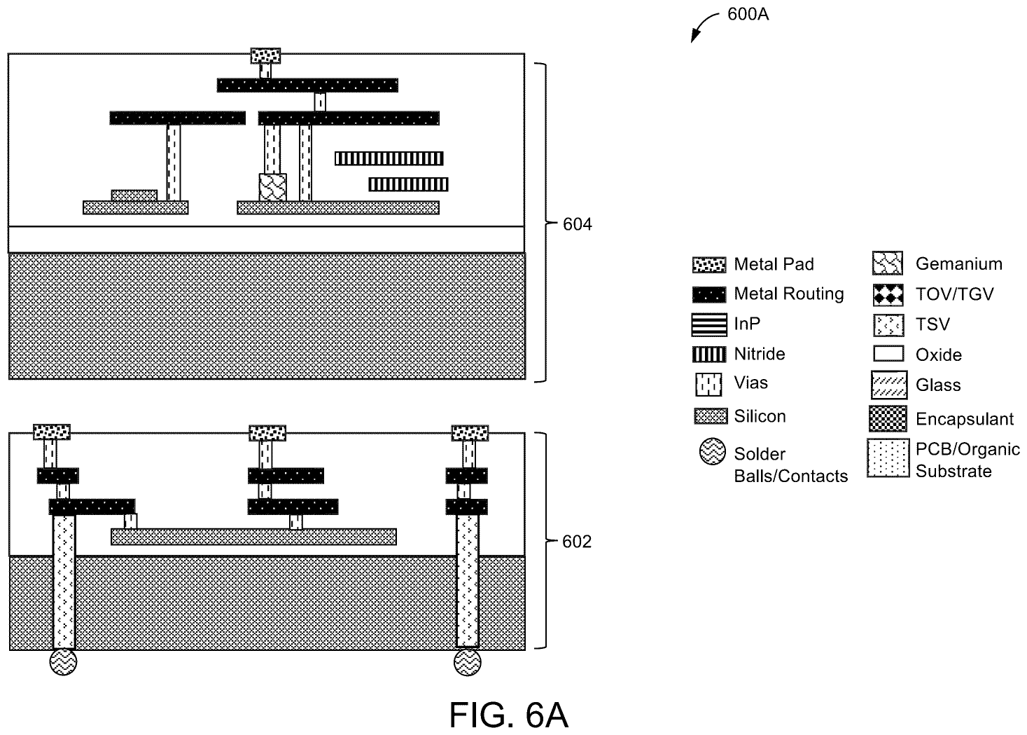

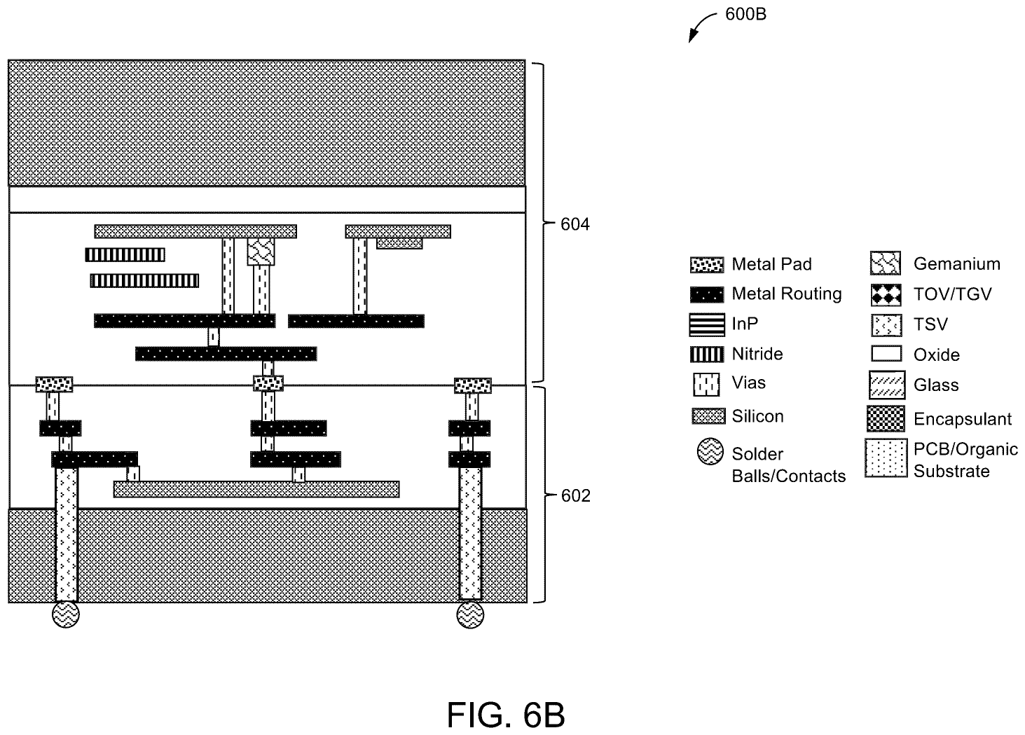

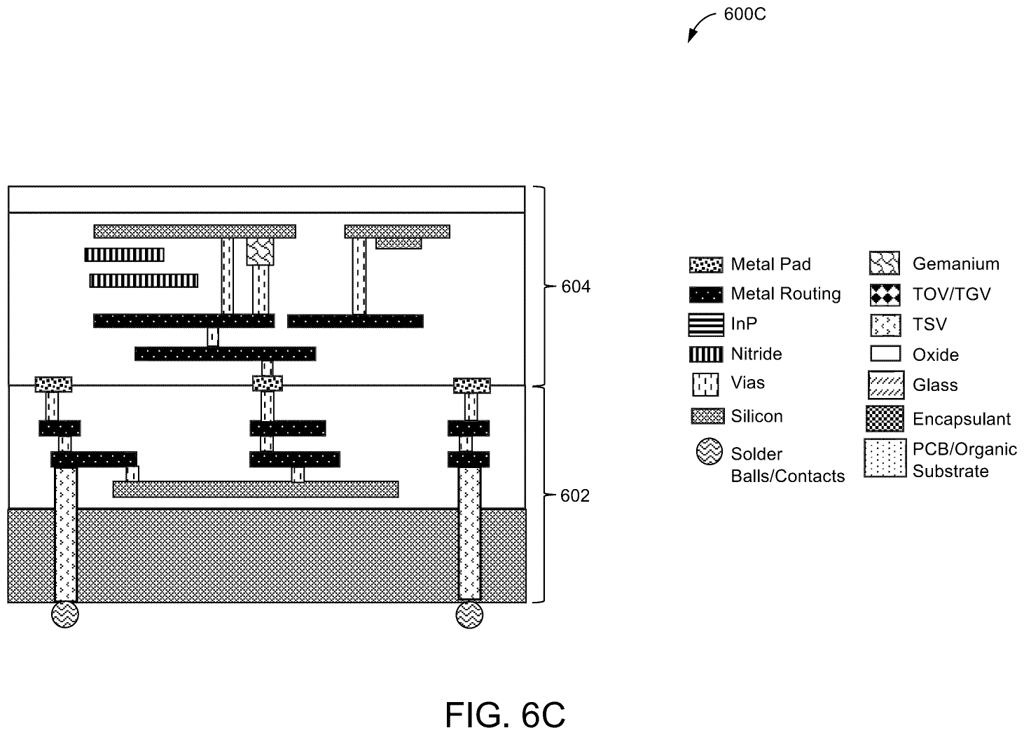

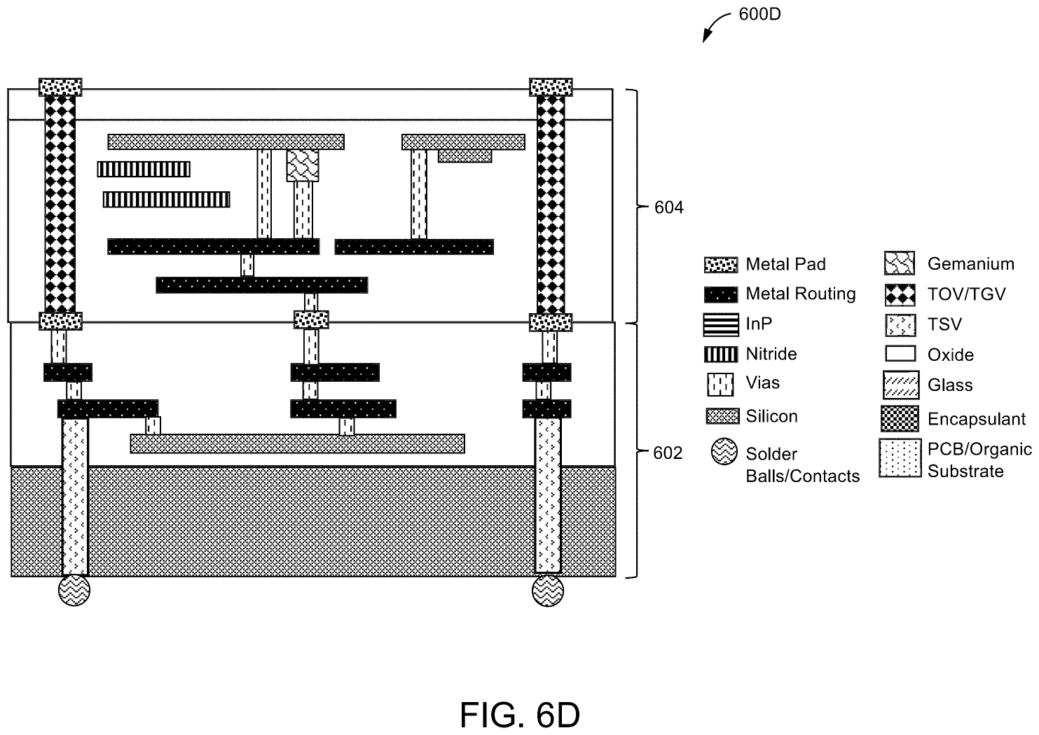

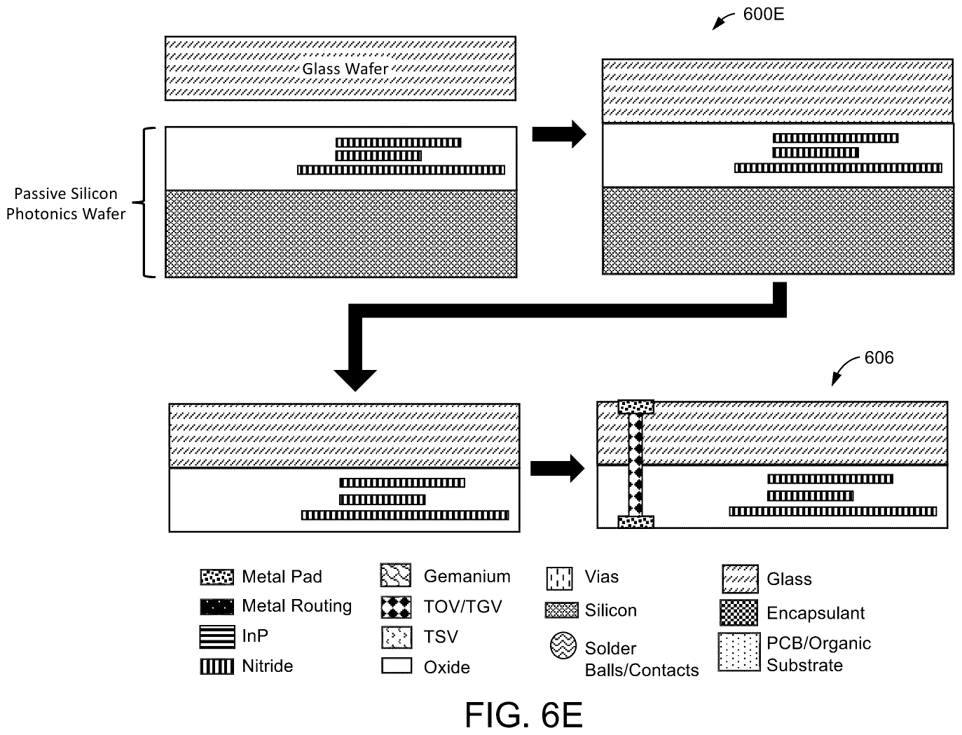

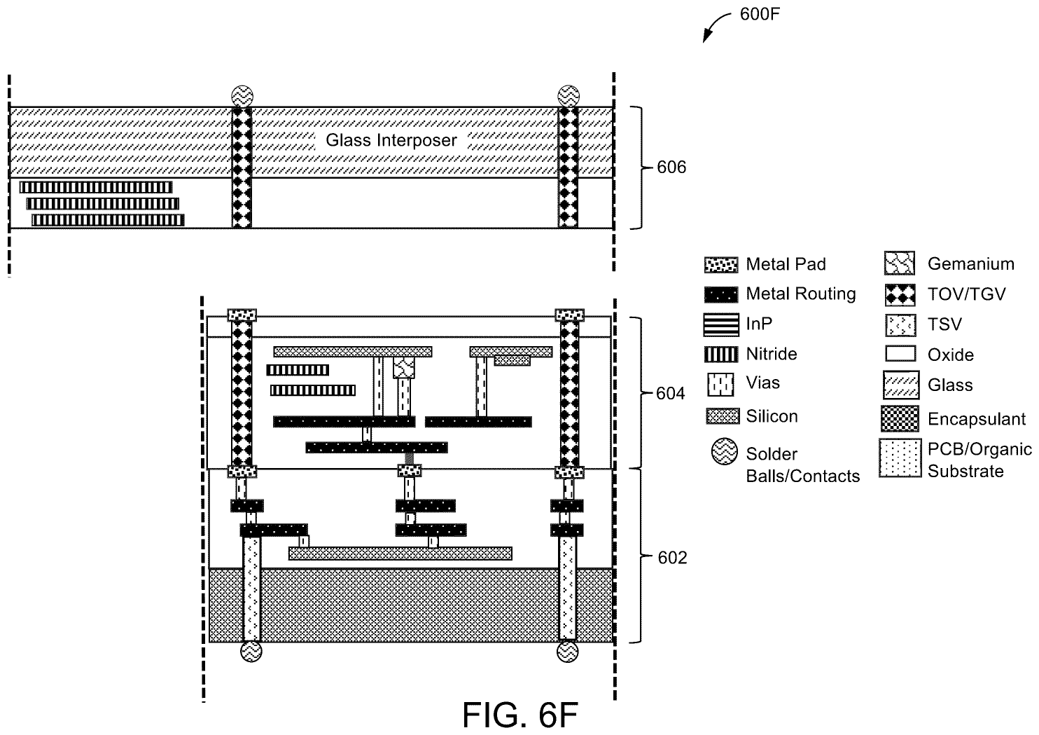

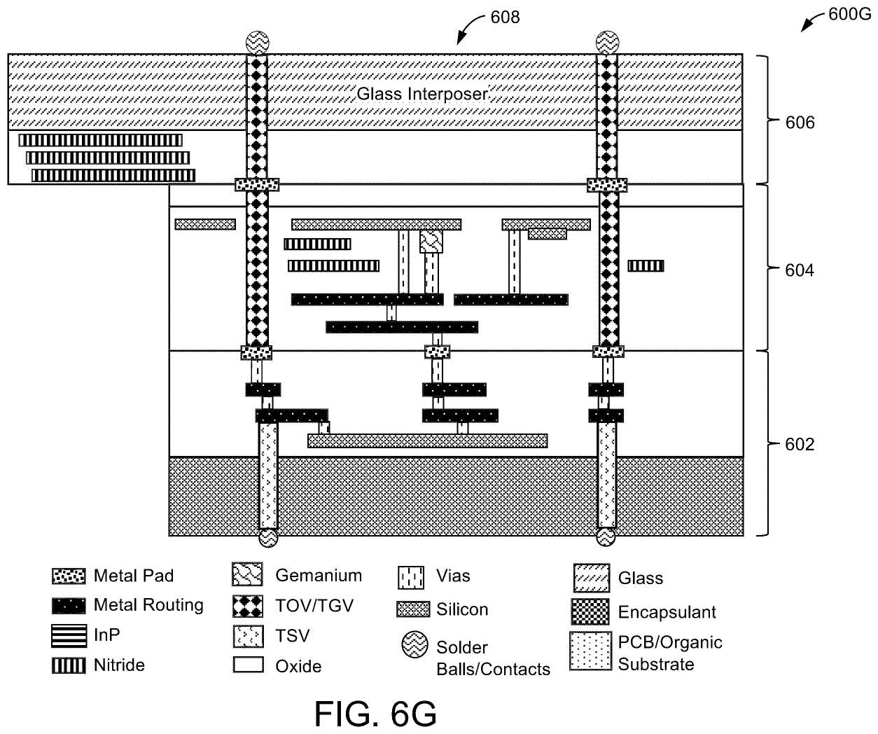

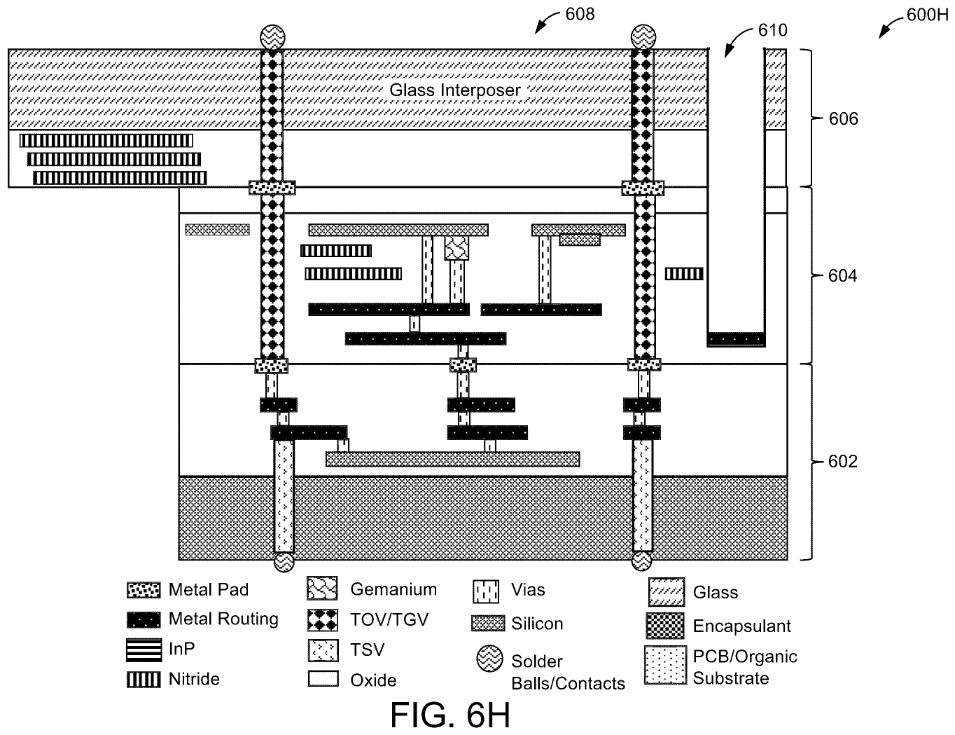

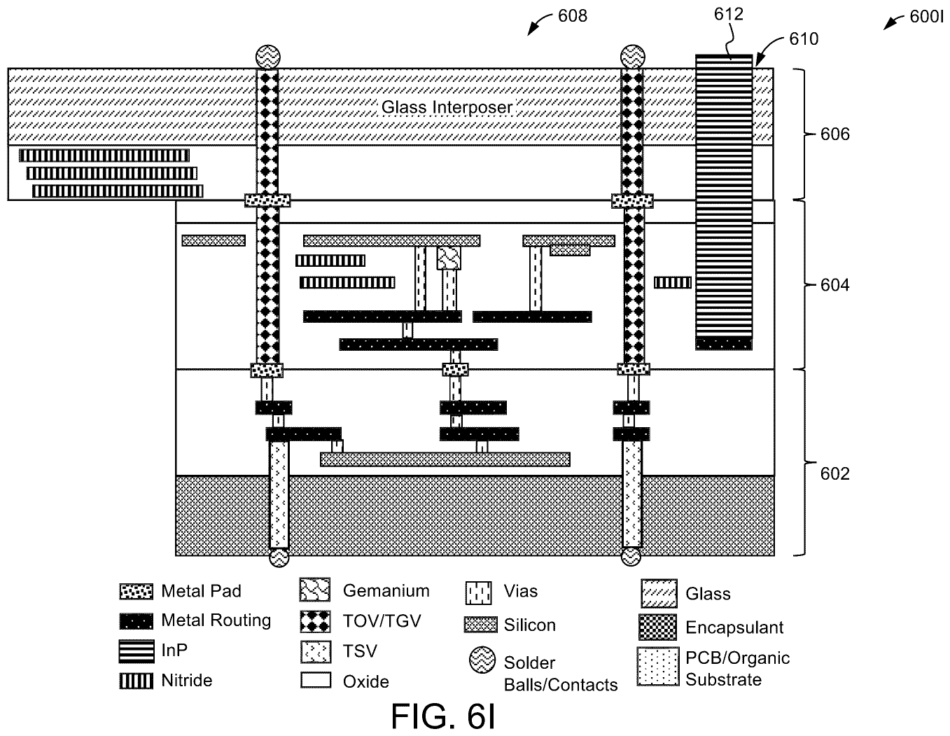

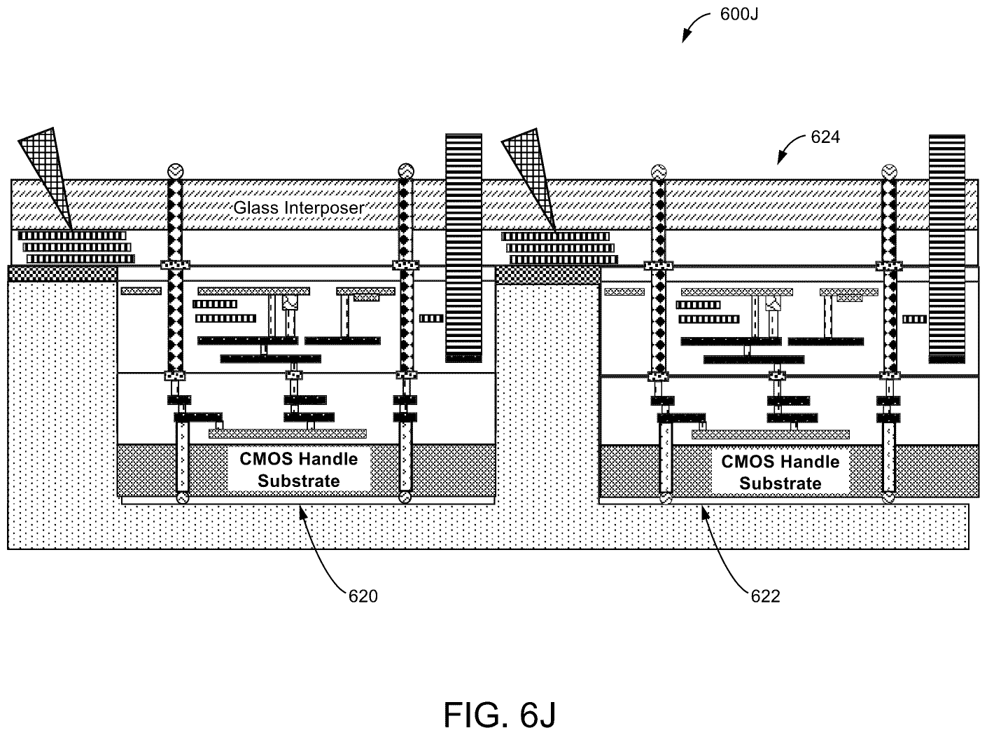

FIGS. 6A-6J show an example process for assembling devices. FIG. 6A shows a step 600A comprising configuring a CMOS device 602 from a portion of a wafer and a silicon photonic device 604 from a portion of a wafer. In some examples, the silicon photonic device 604 can be an active photonic device or chip. The CMOS device 602 and the silicon photonics device 604 each comprise respective components identified by the key to the right of FIG. 6A. In some examples, the silicon photonics device 604 can be fabricated using an active process. During step 600B, as shown in FIG. 6B, the silicon photonics device 604 is flipped onto the CMOS device 602. In some examples, this flip-chip step can be performed at the wafer scale such that the wafer comprising the CMOS device 602 and the wafer comprising the silicon photonics device 604 are bonded on the wafer scale. The bonding process includes a bond of the wafer oxide surfaces and a bond of the metal pads to allow electrical connection between the CMOS device 602 and the silicon photonic device 604. After bonding the wafers, the silicon handle substrate is removed from the silicon photonic device 604, as illustrated in step 600C depicted in FIG. 6C. After removal of the handle wafer, through oxide vias (TOVs) are added to allow electrical connections to pass through the photonic device layer down to the CMOS device 602, as shown step 600D depicted in FIG. 6D. After adding the TOVs, the wafer can be diced into individual chips. A glass interposer 606 is constructed by bonding a glass wafer to a passive silicon photonic wafer and then debonding the silicon handle wafer, as shown in FIG. 6E. The glass interposer 606 is then diced into individual chips and bonded to the silicon photonic device 604, as shown in step 600F depicted in FIG. 6F. The resulting device 608, shown in step 600G depicted in FIG. 6G comprises the CMOS device 602, the silicon photonic device 604, and the glass interposer 606. In other words, the device 608 comprises an active photonic chip, i.e., the silicon photonic device 604, and a passive photonic chip, i.e., the glass interposer 606. To allow gain media to be integrated into the chip, a trench 610 can be etched down into the device 608 through the glass interposer 606 and the silicon photonic device 604, as shown by step 600H depicted in FIG. 6H. A chip 612 containing III/V materials, for example, with quantum wells implemented on an InP platform, can then be flipped into the trench 610, yielding the device 608 shown in FIG. 6I. This assembly process can be used to couple multiple hybrid active-photonic-CMOS chips into a larger chip by using the passive photonic chip to route light between the active chips. This coupling is illustrated in FIG. 6J, which shows a first hybrid active-photonic-CMOS chip 620 and a second hybrid-active-photonic CMOS chip 622 coupled by a single passive photonic chip 624. While coupling between two chips is shown in FIG. 6I, the methods described here can be used to couple an arbitrary number of such chips, with dense optical routing between the chips enabled by one or more passive photonic chips. In some examples, a CMOS wafer can also comprise TOVs.

The modular packaging process described above makes use of photonic chips which are stacked vertically and bonded over an interface through which light can be transferred between the chips. For example, an active photonic circuit which includes an array of optical phase shifters can be bonded to a region of a passive photonic circuit which contains an array of antennas so that, by combining the functionality of both chips, the device can operate as an optical phased array where the beam emitted by the antennas on the passive chip is steered by the phase shifters residing on the active chip. As another example, if a system requires a photonic integrated circuit which contains active components fabricated with a process that is incompatible with low-loss waveguides, an active photonic chip could be interfaced to a passive photonic chip where the waveguide loss can be kept low. To reduce losses, light from the active chip could then be coupled into the passive chip, routed over a long distance with minimal loss, and then coupled back into the active chip. Passing light across the interface between chips requires the use of an optical coupler. Such a coupler can be implemented using adiabatic couplers or using gratings (discussed in more detail below). As discussed below, these couplers can be arrayed to enable high-density chip-to-chip photonic interconnects.

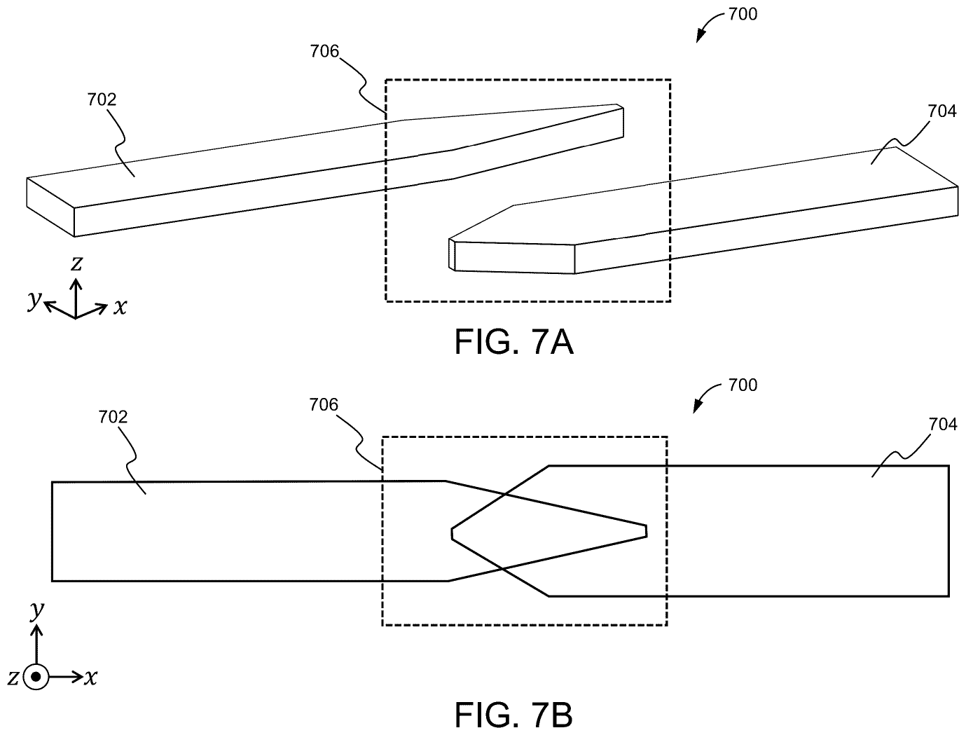

FIG. 7A shows a perspective view of an example adiabatic coupler 700 that can be used to couple light vertically across the interface between two photonic chips. FIG. 7B depicts a top view of the example adiabatic coupler 700. The adiabatic coupler 700 comprises a first waveguide coupler 702 and a second waveguide coupler 704. In some implementations, a first chip (not shown) can comprise the first waveguide coupler 702 and a second chip (not shown) can comprise the second waveguide coupler 704. As shown in FIG. 7A, the first waveguide coupler 702 and the second waveguide coupler 704 are stacked in the z-direction, so that the first waveguide coupler 702 is positioned at a larger z-coordinate compared to the second waveguide coupler 704. The first waveguide coupler 702 is in proximity to the second waveguide coupler 704 within a distance that supports evanescent optical coupling between the first waveguide coupler 702 and the second waveguide coupler 704 that are overlapped within a coupling region 706. In some implementations, the interface between the first chip and the second chip can form a plane parallel to the x-y plane. In some examples, the interface between the chips does not need to cover the entire surface of either chip but can be restricted to a region or portion of each of the chips. As illustrated in FIGS. 7A-7B, the widths of the first waveguide coupler 702 and the second waveguide coupler 704 are adiabatically tapered along the length of the waveguide couplers in the coupling region 706. This adiabatic tapering allows the mode associated with one waveguide coupler to be adiabatically converted into the mode associated with the other waveguide coupler, allowing light to be transferred from one waveguide coupler to the other. In some examples, each waveguide coupler can be at the end of a corresponding waveguide such that light from a waveguide can propagate to the first waveguide coupler 702, be coupled into the second waveguide coupler 704, and then propagate into another waveguide from the second waveguide coupler 704.

To implement an adiabatic coupler between two photonic chips, the chips can be aligned so that the tapered waveguides on the two chips are in close proximity. However, imperfections in the packaging process can result in the chips being misaligned and, as a result, the coupling efficiency can decrease. To decrease the sensitivity of the coupler to misalignment, the taper can be designed so that the mode expands significantly as it propagates through the taper. In such a design, distributing the mode over a larger spatial region (i.e., such that the mode has a larger mode diameter) can enable the device to be less sensitive to misalignment between a tapered waveguide in a first chip and a tapered waveguide in a second chip.

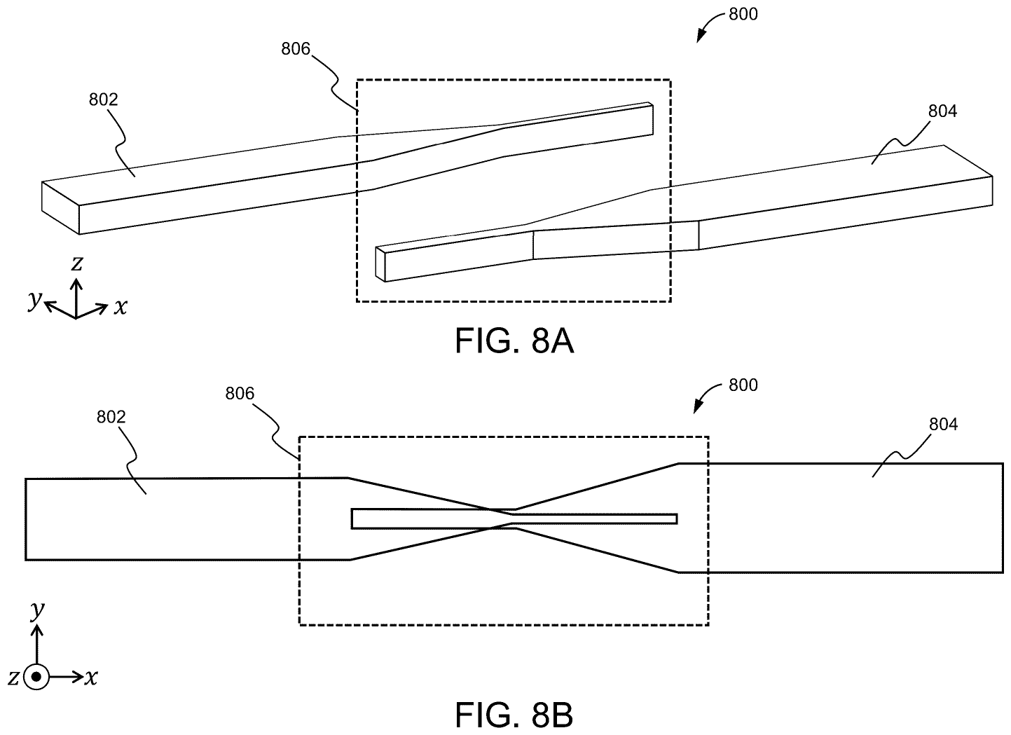

FIG. 8A shows a perspective view of an example adiabatic coupler 800 and FIG. 8B shows a top view of the adiabatic coupler 800. The adiabatic coupler 800 comprises a first waveguide coupler 802 and a second waveguide coupler 804. The first waveguide coupler 802 is in proximity to the second waveguide coupler 804 within a distance that supports evanescent optical coupling between the first waveguide coupler 802 and the second waveguide coupler 804 that are overlapped within a coupling region 806. In this design, the first waveguide coupler 802 and the second waveguide coupler 804 each comprise portions in the coupling region 806 where the width of each waveguide coupler 802, 804 is small so that the mode in the respective portion has a large mode diameter. As a result of these portions, the adiabatic coupler 800 can tolerate larger misalignments between the two waveguides in the y and z directions.

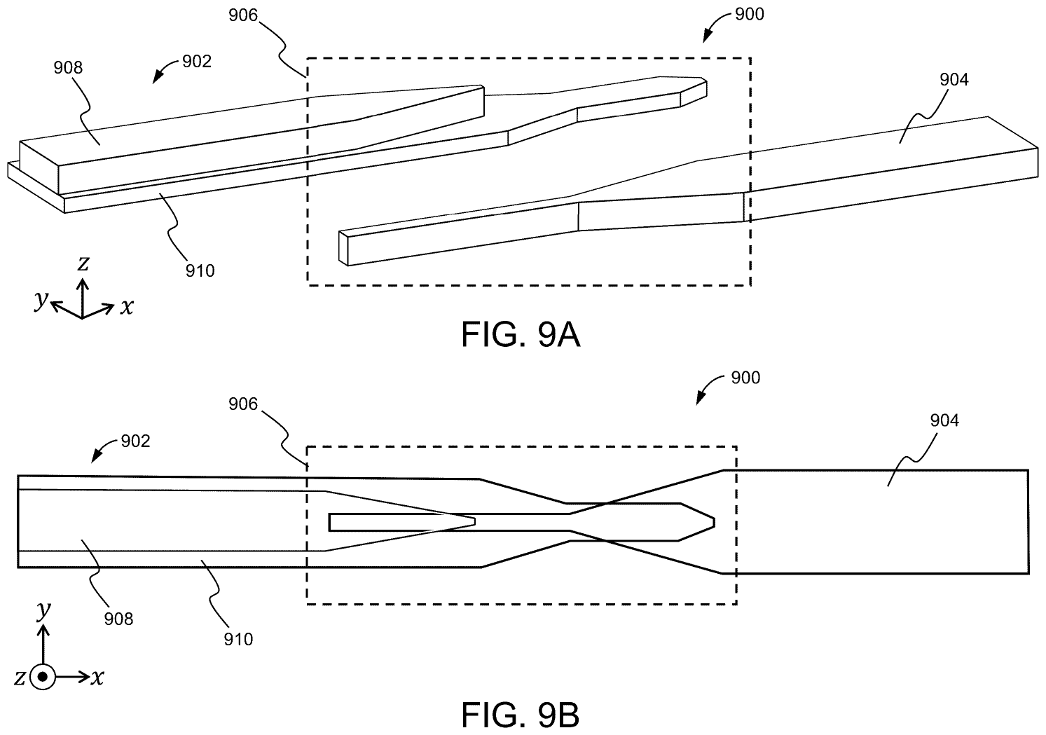

FIGS. 9A-9B shows another example adiabatic coupler 900 that can similarly achieve improved alignment tolerances by expanding the mode diameter in the region with the adiabatic taper. FIG. 9A depicts a perspective view of the adiabatic coupler 900 while FIG. 9B depicts a top view of the adiabatic coupler 900. The adiabatic coupler 900 comprises a first waveguide coupler 902 and a second waveguide coupler 904. In some examples, the first waveguide coupler 902 can be in a first chip (not shown) and the second waveguide coupler 904 can be in a second chip (not shown) to facilitate coupling between the first chip and the second chip. The first waveguide coupler 902 is in proximity to the second waveguide coupler 904 within a distance that supports evanescent optical coupling between the first waveguide coupler 902 and the second waveguide coupler 904 that are overlapped within a coupling region 906. In this example, the first waveguide coupler 902 is constructed using two different layer heights shown by layers 908, 910 that are formed from a core guiding material. For example, the core guiding material could be constructed from a combination of a 220 nm height silicon layer combined with a partial ridge etch that produces a region with a reduced silicon height layer. In some examples, the 220 nm silicon layer can be referred to as a full-height layer 908 while the reduced silicon height layer can be referred to as a partial-height layer 910. With reference to FIGS. 9A-9B, the word height refers to the waveguide dimension measured along the z direction. While silicon is used as an example material here, other materials can also be used to form the waveguide couplers. The adiabatic taper of the first waveguide coupler 902 comprises two stages. First, the width (measured in the y-direction) of the full-height layer 908 is tapered to transfer the mode into the partial-height layer 910. Then the width, as measured in the y-direction, of the partial-height layer 910 is tapered down to further expand the mode. In other words, the first waveguide coupler 902 comprises a first adiabatic taper and a second adiabatic taper within the coupling region 906, where the first adiabatic taper has a first cross section and the second adiabatic taper has a second cross section that is different than the first cross section. By transferring the mode into a narrow-width region composed of partial-height layer 910, the mode can have a larger mode diameter than it would if the taper were constructed purely using the full-height layer 908. The second waveguide coupler 904 also tapers to a region where the mode has a large diameter. In FIGS. 9A-9B, the taper of the second waveguide coupler 904 is shown as being constructed from a single-height core layer. This single-height design could be used, for instance, if the material used to construct the second waveguide coupler 904 is a low index contrast material, such as silicon nitride embedded in glass, which may make the use of a partial-height region unnecessary. However, a two-height design such as the one used for the taper of the first waveguide coupler 902 could also be used for the second waveguide coupler 904. In that case, the waveguide structures can be inverted so that the wider portion of the full-height silicon is on the top instead of the bottom, or the waveguide structures can have the same orientation with the wider portion of the full-height silicon on the bottom and the narrower portion of the full-height silicon on the top. In either orientation, the two partial-height regions can be adjacent to each other such that they overlap each other.

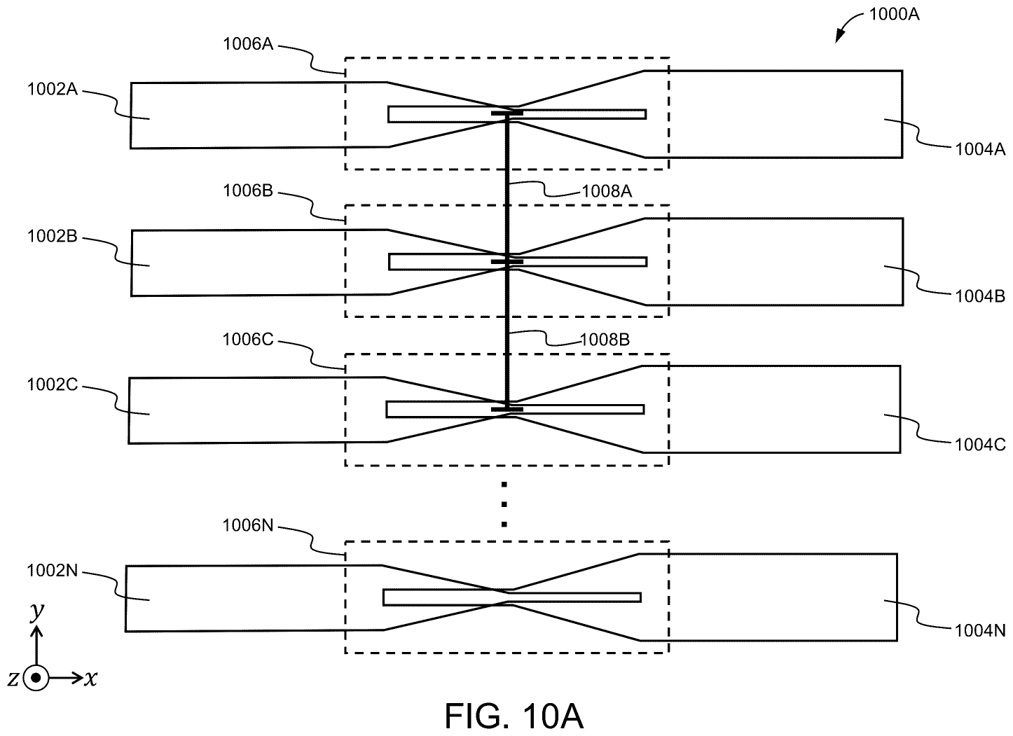

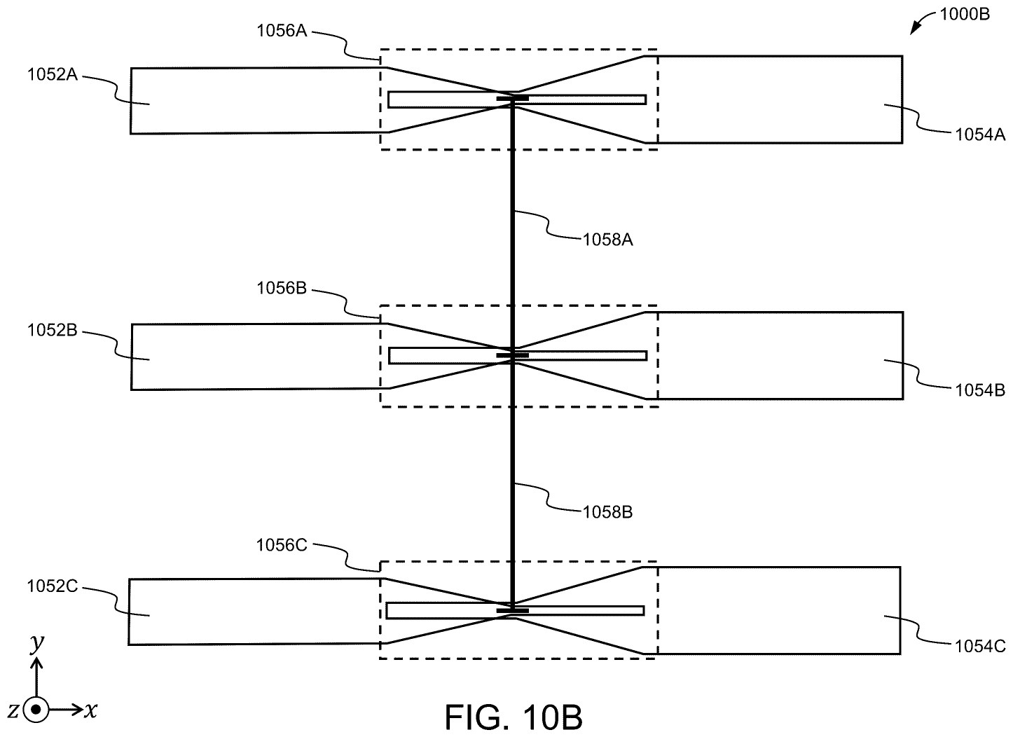

By fabricating an array of the type of adiabatic couplers described above, many independent optical channels can be coupled between photonic chips, allowing for implementation of dense optical chip-to-chip interconnects. An example of this type of configuration is illustrated in FIG. 10A, which shows a top view (in the xy plane) of an adiabatic coupler array 1000A where the individual couplers in the array utilize the design previously shown in FIGS. 8A-8B. The adiabatic coupler array 1000A comprises a first plurality of waveguide couplers 1002A-1002N and a second plurality of waveguide couplers 1004A-1004N. In some examples, the first plurality of waveguide couplers 1002A-1002N can be in a first photonic chip (not shown) and the second plurality of waveguide couplers 1004A-1004N can be in a second photonic chip (not shown). Each waveguide coupler of the first plurality of waveguide couplers 1002A-1002N is overlapped with a respective waveguide coupler of the second plurality of waveguide couplers 1004A-1004N in a respective coupling region 1006A-1006N. As shown in FIG. 10A, each waveguide coupler of the first plurality of waveguide couplers 1002A-1002N and each waveguide coupler of the second plurality of waveguide couplers 1004A-1004N comprise respective adiabatic tapers within the respective coupling regions 1006A-1006N. In some implementations, other coupler designs can also be used for the individual couplers in the array. As before, the two photonic chips are assumed to be stacked in the z-direction (out of the page in FIG. 10A), so that the first chip resides at a larger z-coordinate compared to the second chip and the interface between the two chips forms a planar region parallel to the x-y plane.

In some examples, each waveguide coupler of the first plurality of waveguide couplers 1002A-1002N can be at an end of a corresponding waveguide on the first photonic chip (not shown). In some examples, each of these corresponding waveguides can be arranged to have respective propagation axes that are all parallel to a common axis in this region of the first photonic chip. For instance, each of the corresponding waveguides can have respective propagation axes that are all parallel to the x-axis of FIG. 10A. In some examples, each waveguide coupler of the first plurality of waveguide couplers 1002A-1002N can be substantially coplanar with a first plane that is parallel to this common axis, i.e., the x-axis. The first plane could be, for instance, a plane that is parallel to the xy plane. Likewise, each waveguide coupler of the second plurality of waveguide couplers 1004A-1004N can be at an end of a corresponding waveguide on the second photonic chip (not shown). Similarly, each of the corresponding waveguides can have respective propagation axes that are all parallel to a common axis in this region of the second photonic chip. In some examples, each waveguide coupler of the second plurality of waveguide couplers 1004A-1004N can be substantially coplanar with a second plane that is parallel to each of the common axis, i.e., the x-axis, and the first plane. The second plane could be, for instance, a plane that is parallel to the xy plane.

As shown in FIG. 10A, a portion of each waveguide coupler of the first plurality of waveguide couplers 1002A-1002N that is contained within a coupling region 1006A-1006N can be contained within a third plane that is perpendicular to the first plane and perpendicular to the common axis, i.e., the x-axis. In this example, the third plane could be a plane that is parallel to the yz plane. Further, a portion of each waveguide coupler of the second plurality of waveguide couplers 1004A-1004N that is contained within a coupling region 1006A-1006N can be contained within a fourth plane that is perpendicular to the first plane and perpendicular to the common axis. In this example, the fourth plane could be a plane that is parallel to the yz plane such that the third plane and the fourth plane are distributed along the common axis.

By way of example, referring to FIG. 10A, the waveguide coupler 1002B can be separated from the waveguide coupler 1002A and the waveguide coupler 1002C by a separation distance along the y-axis. Separating the waveguide couplers in this way can also separate the associated coupling regions. By way of example, the coupling region 1006B is separated from the coupling region 1006A by separation distance 1008A and is separated from the coupling region 1006C by separation distance 1008B. This separation distance along the y-axis can be referred to as waveguide pitch.

In some implementations, configuring waveguide couplers and coupling regions can be associated with reducing crosstalk between optical waves propagating in each of the waveguide couplers and/or coupling regions. Some configurations can comprise separating adjacent waveguide couplers or coupling regions by a separation distance that is based on a maximum length associated with the coupling region. For example, a maximum length of a coupling region can be length in which an optical wave transitions from the first waveguide coupler of the coupling region into the second waveguide coupler of the coupling region. In some examples, each adjacent coupling region can be separated by a separation distance that is larger than a maximum length of each of the coupling regions in the adjacent coupling regions. FIG. 10B depicts an example coupler array 1000B comprising a larger pitch between adjacent waveguide couplers and waveguide coupling regions than the example coupler array depicted in FIG. 10A. The coupler array 1000B comprises a first plurality of waveguide couplers 1052A-1052C and a second plurality of waveguide couplers 1054A-1054C overlapped in respective coupling regions 1056A-1056C. By way of example, the coupling region 1056B is separated from coupling region 1056A by a separation distance 1058A and is separated from coupling region 1056C by a separation distance 1058B. In some implementations, this larger pitch can be associated with reduced crosstalk between adjacent coupling regions.

Referring back to FIG. 10A, a coupler array comprising couplers spaced at a small pitch, also referred to as the separation distance between adjacent couplers, can be desirable to couple light between chips. For example, an optical phased array comprising an array of phase shifters coupled to an array of antenna elements, and implementing smaller antenna/phase-shifter pitches can enable the optical phased array to operate over a larger angular beam steering range. If the phase shifters and antennas are located on separate chips and coupled using the type of adiabatic coupler array discussed above, a coupler array with a small pitch that matches the pitch of the antennas/phase-shifters can be desirable to optimize operating capabilities. As another example, if data is being optically transmitted between the chips, a coupler array with a small pitch can enable dense data transmission from chip to chip, i.e., many channels within a small spatial region.

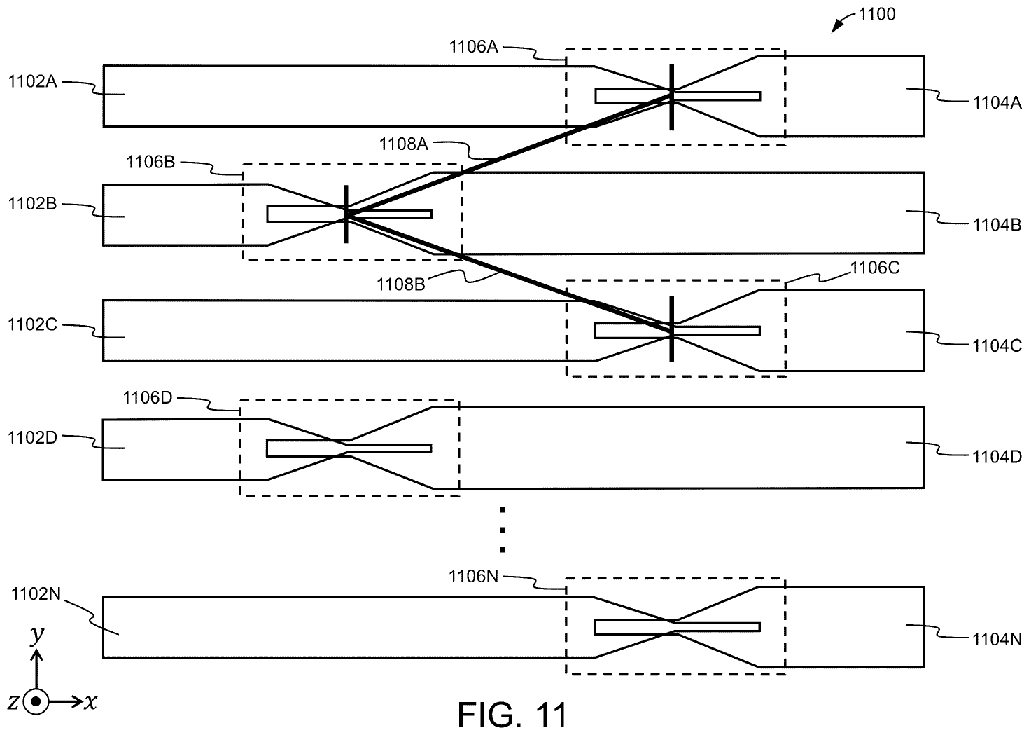

In some implementations, as the pitch of the couplers is decreased, undesirable crosstalk between neighboring couplers can be introduced. To mitigate this crosstalk, neighboring couplers can be staggered, as illustrated by the example coupler array 1100 shown in FIG. 11. The coupler array 1100 comprises a first plurality of waveguide couplers 1102A-1102N and a second plurality of waveguide couplers 1104A-1104N. Each waveguide coupler of the first plurality of waveguide couplers 1102A-1102N is overlapped with a respective waveguide coupler of the second plurality of waveguide couplers 1104A-1104N in a respective coupling region 1106A-1106N. As shown in FIG. 11, adjacent coupling regions 1106A-1106N are displaced relative to each other not only along the y-axis, but also along the axis of the waveguide couplers (the x-axis) so that the tapered regions of the coupling regions 1106A-1106N do not overlap along the x-axis (as they do in the coupler arrays 1000A and 1000B). By way of example, the coupling region 1106B can be separated by a diagonal separation distance 1108A from the coupling region 1106A and by a diagonal separation distance 1108B from the coupling region 1106C. This enables a smaller pitch without significant crosstalk. As an example, when the mode is expanded in the tapered region of the first waveguide coupler 1102B in the coupling region 1106B, it can be phase mismatched from the neighboring coupling regions 1106A, 1106C due to the fact that the neighboring waveguide couplers 1102A, 1102C and 1104A, 1104C each have a different respective cross sections near the coupling region 1106B. This difference in cross sections can result in a mismatch in propagation constants of the modes of the coupling region 1106B. Because the modes are phase mismatched, the crosstalk between adjacent coupling regions 1106A, 1106C can be reduced.

The example coupler array 1100 depicted in FIG. 11 is configured to suppress crosstalk between adjacent coupling regions. In some examples, the separation distances between adjacent couplers can be described relative to a common axis associated with optical waves propagating in the waveguide couplers or coupling regions. By way of example, each of the waveguide couplers 1102A-1102N can be parallel to a common axis, in this case the x-axis. Each waveguide coupler 1102A-1102N is offset relative to adjacent waveguide couplers along the common axis such that the separation distances 1108A, 1108C each form a nonzero angle relative to the x-axis and the y-axis.

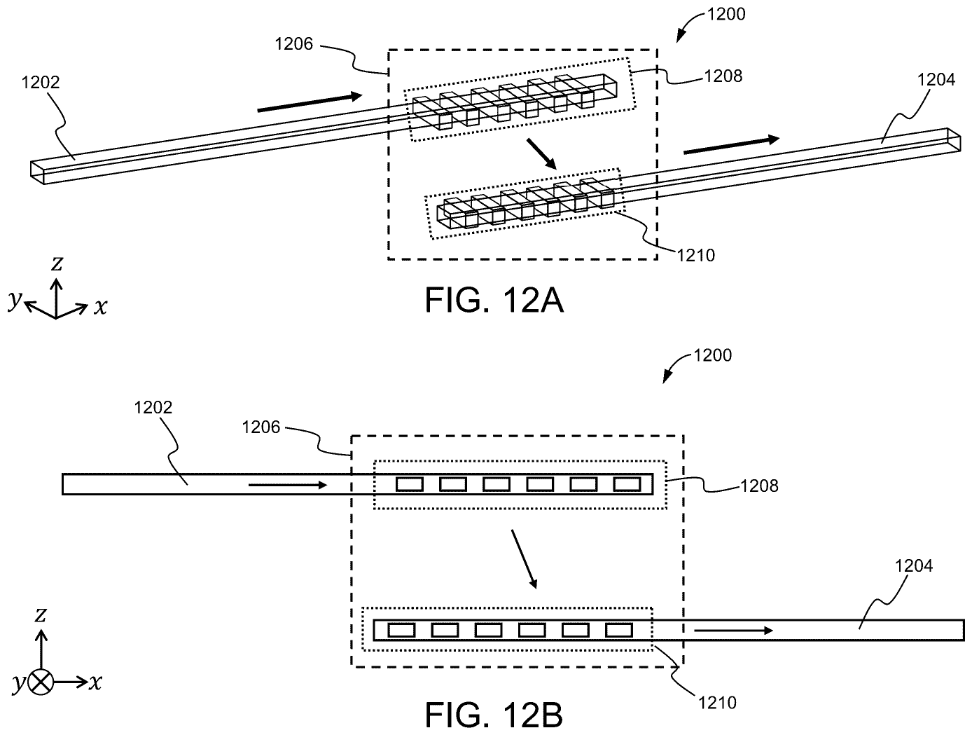

Gratings can also be used to couple light across the interface between the stacked chips. A perspective view of an example coupler 1200 is illustrated in FIG. 12A and a side view of the coupler 1200 is shown in FIG. 12B. The coupler 1200 comprises a first waveguide coupler 1202 in a first chip (not shown) and a second waveguide coupler 1204 in a second chip (not shown) with propagating light shown by arrows. The first waveguide coupler 1202 and the second waveguide coupler 1204 are overlapped in coupling region 1206. In this design, the first waveguide coupler 1202 comprises a first grating 1208 and the second waveguide coupler 1204 comprises a second grating 1210. Light traveling through the first waveguide coupler 1202 is emitted by the first grating 1208 and then coupled into the second waveguide coupler 1204 via the second grating 1210. While the gratings illustrated in FIGS. 12A-12B are shown with a single layer of perturbations, multiple layers of perturbations, residing at different z coordinates, can be used to make the grating emission directional e.g., so that the first grating 1208 emits primarily downward in the negative z direction, and the second grating 1210 primarily receives light that is incident from above.

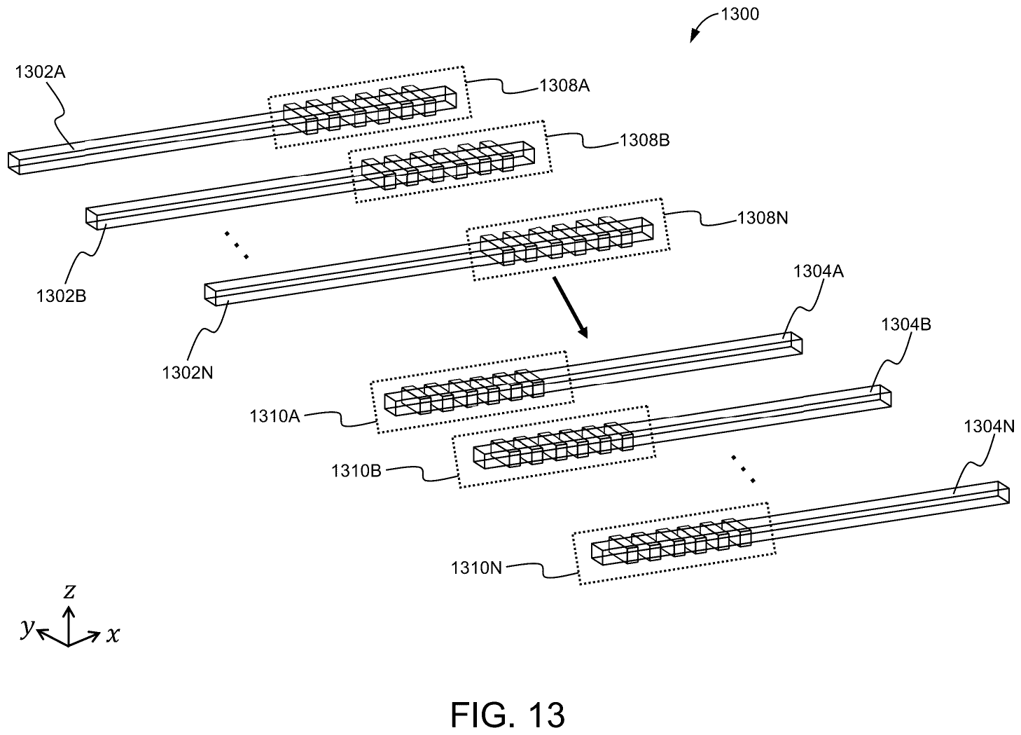

Grating couplers can also be used to couple light between arrays of waveguides on two chips. A perspective view of an example configuration of a coupling array 1300 is illustrated in FIG. 13. The coupling array 1300 comprises a first plurality of waveguide couplers 1302A-1302N and a second plurality of waveguide couplers 1304A-1304N, each arranged on a respective first chip and second chip (not shown) along the y-direction. Each waveguide coupler of the first plurality of waveguide couplers 1302A-1302N comprises a respective grating coupler 1308A-1308N and each waveguide coupler of the second plurality of waveguide couplers 1304A-1304N comprises a respective grating coupler 1310A-1310N. Each grating coupler 1308A-1308N couples light into a respective grating coupler 1310A-1310N. This type of configuration could be useful, for example, for optical phased arrays where a large number of optical phase shifters reside on a first chip configured as an active chip, a large array of antennas reside on a second chip configured as a cheaper passive chip, and grating couplers allow light to be coupled across the interface between the two chips. One benefit of this type of configuration is that it can allow the grating antennas or grating couplers, which can occupy a large chip area, to be implemented using a cheaper passive process, which can reduce the overall system cost.

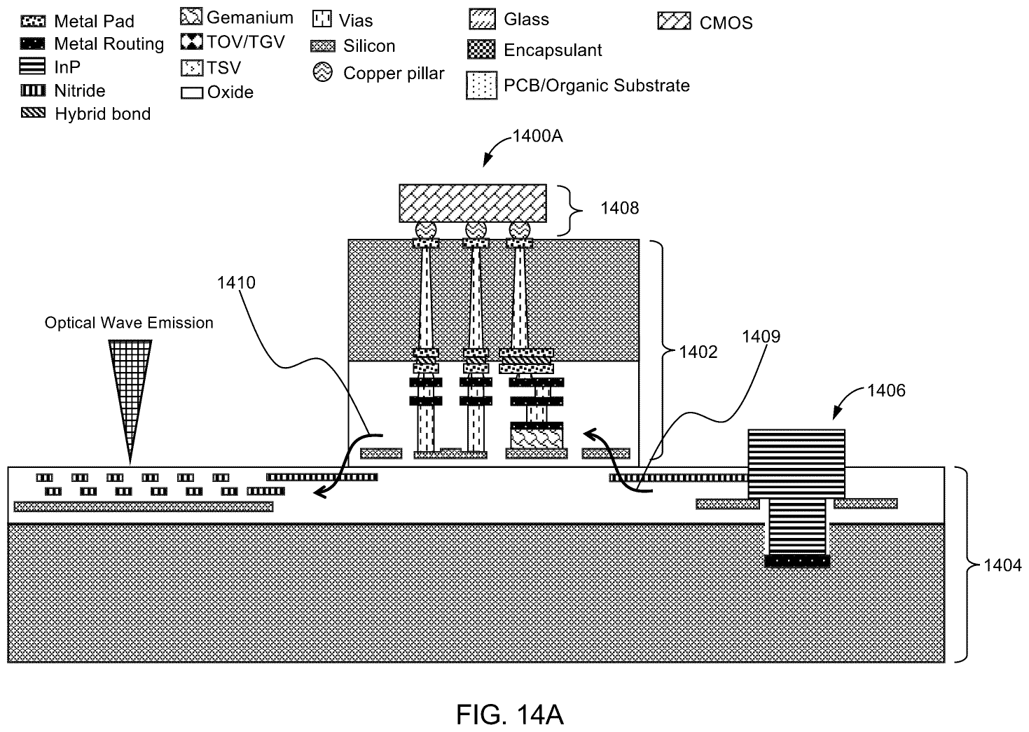

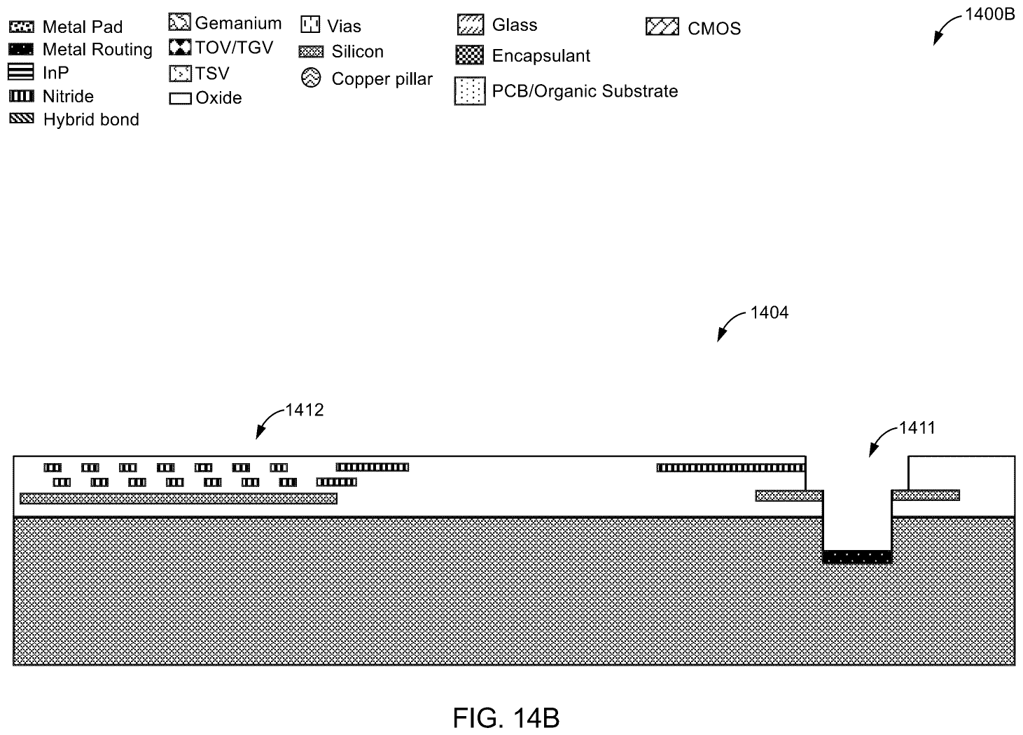

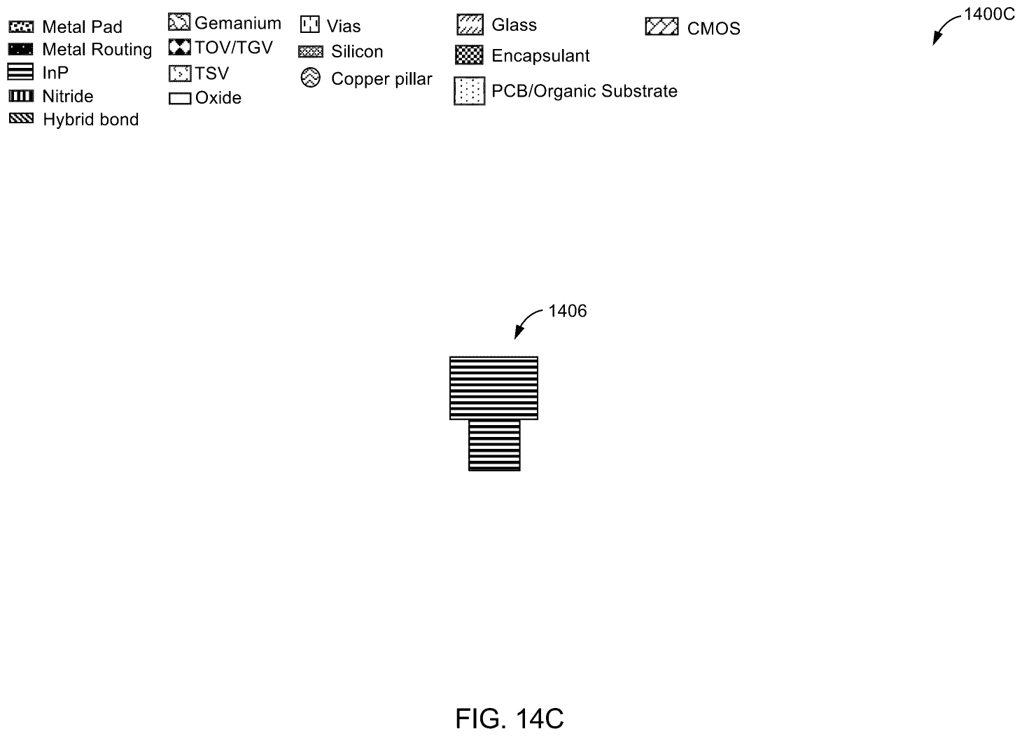

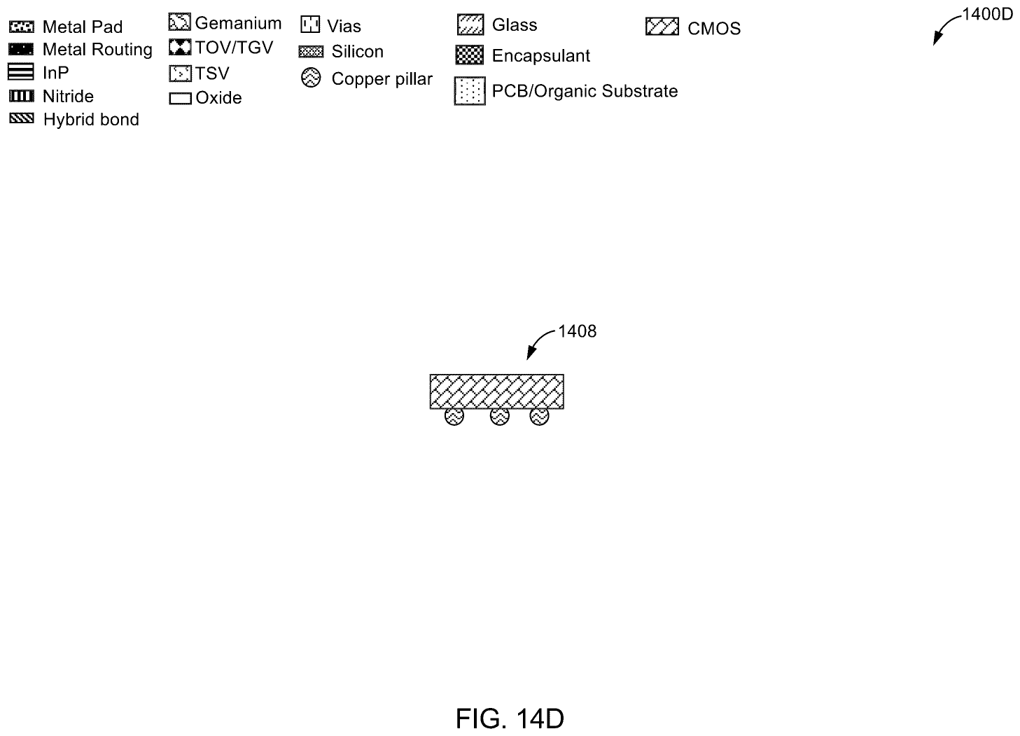

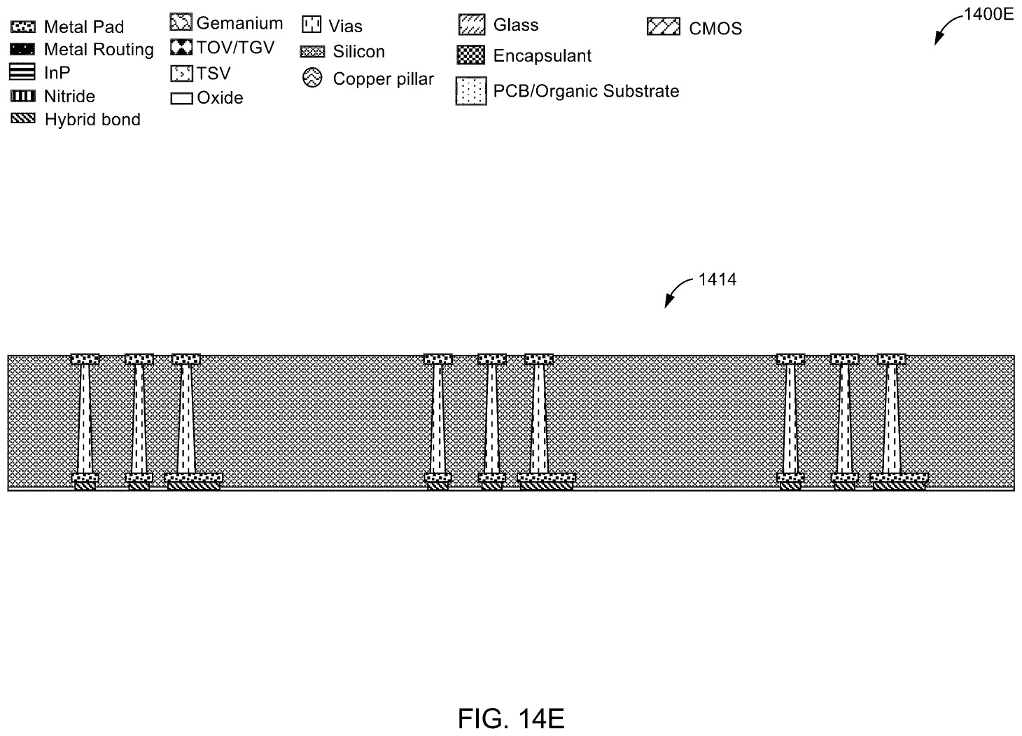

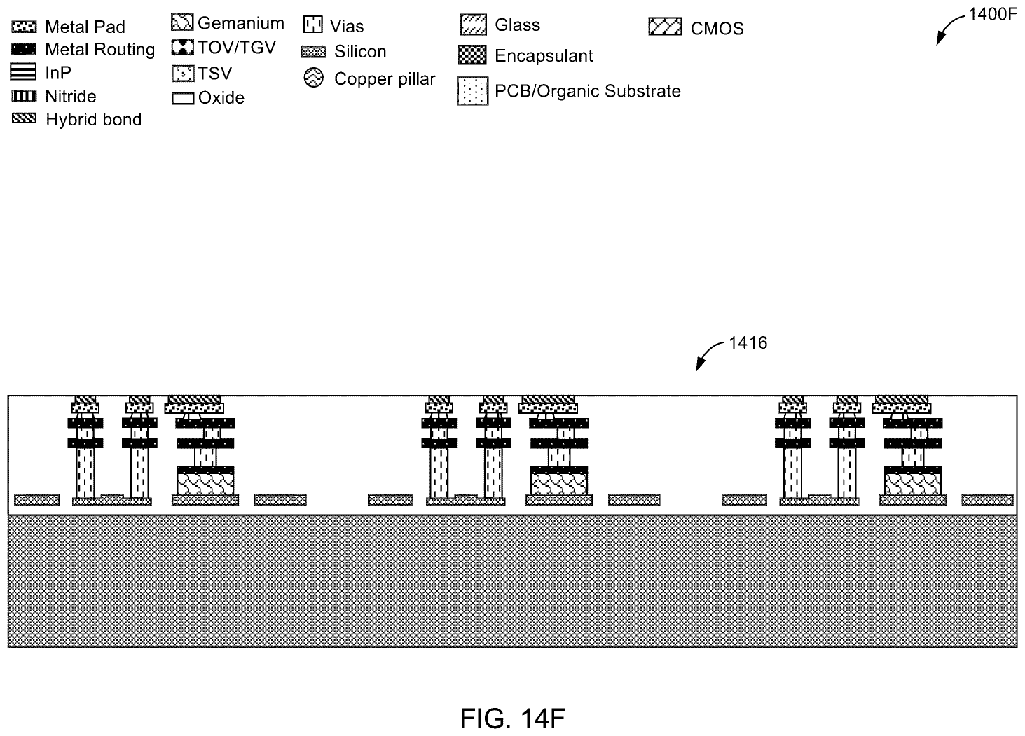

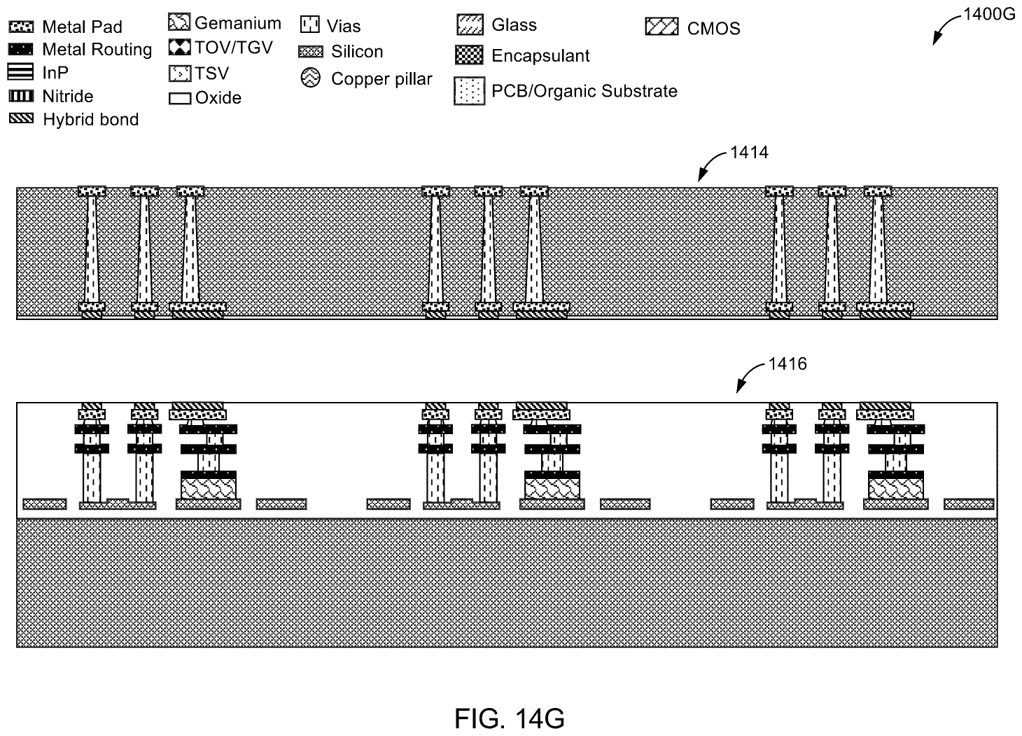

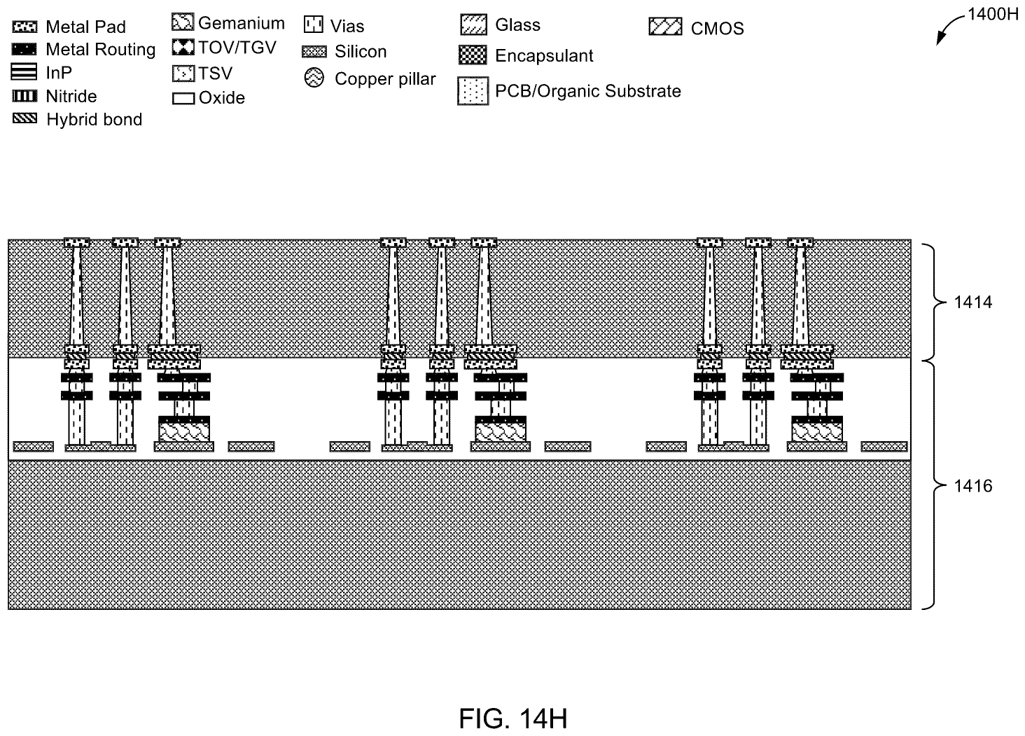

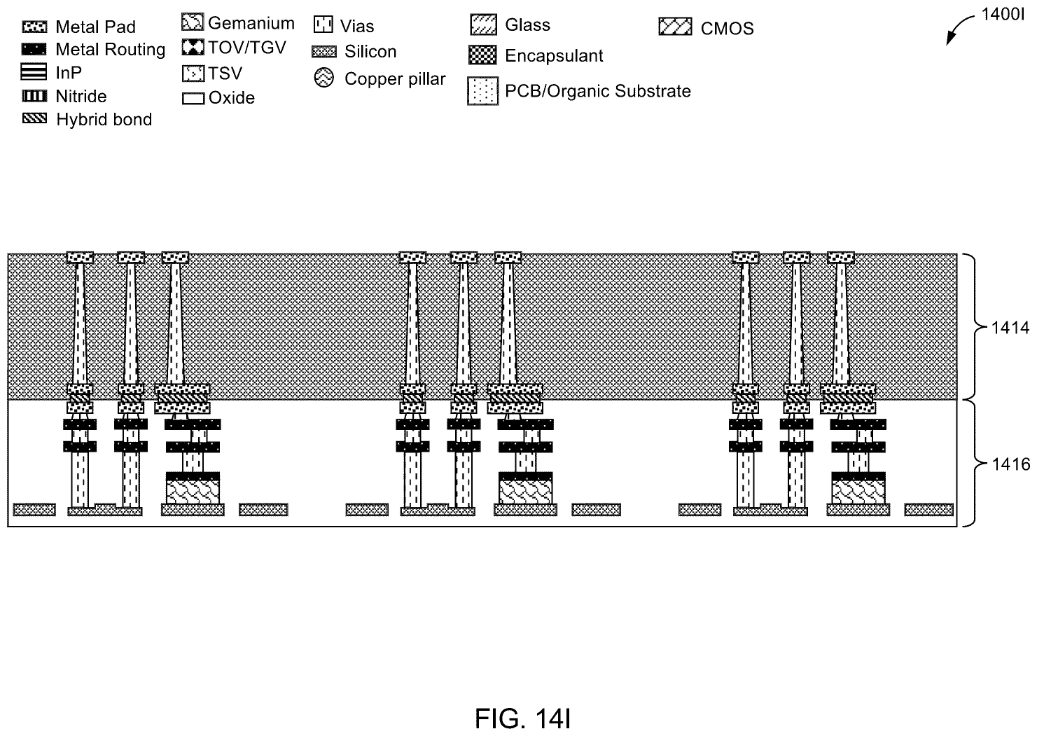

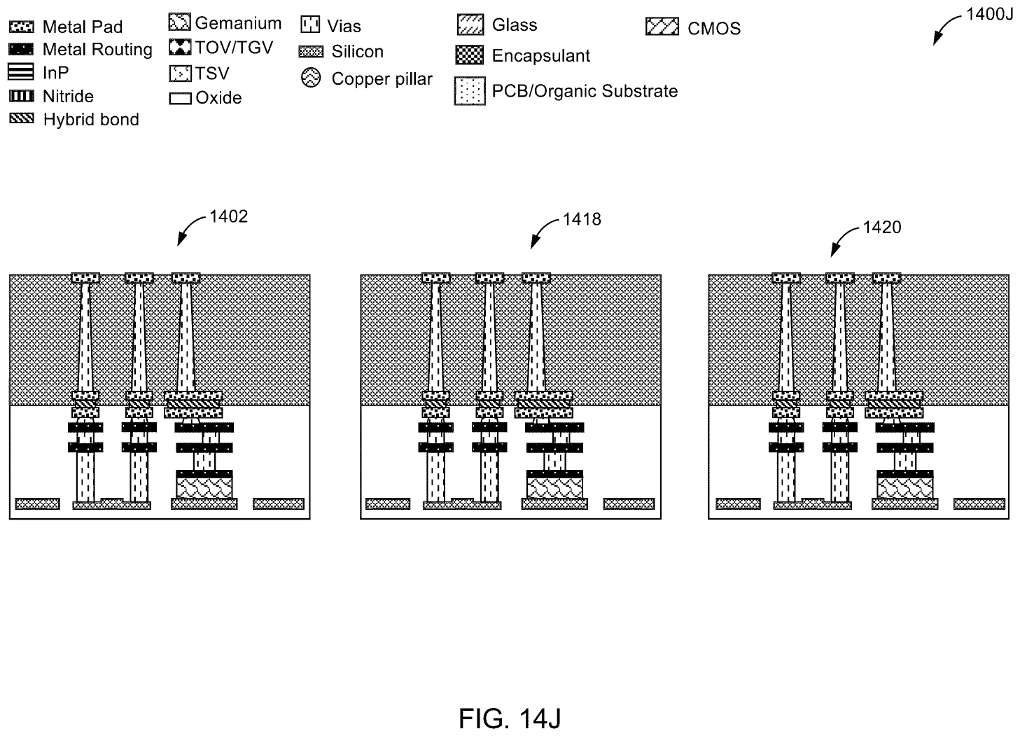

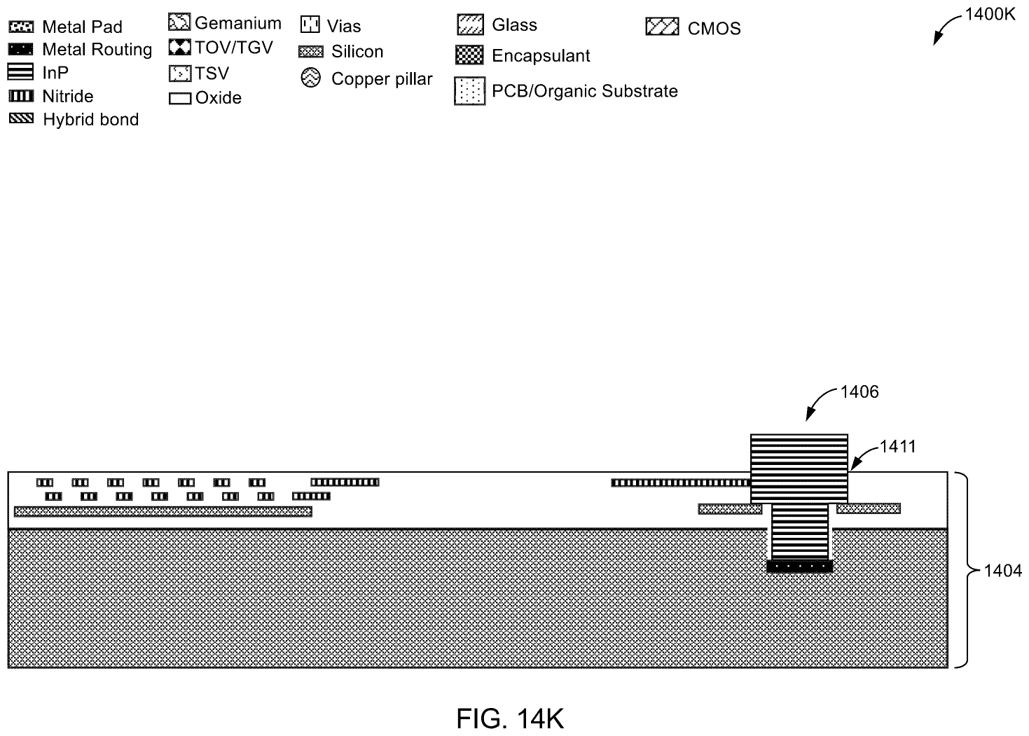

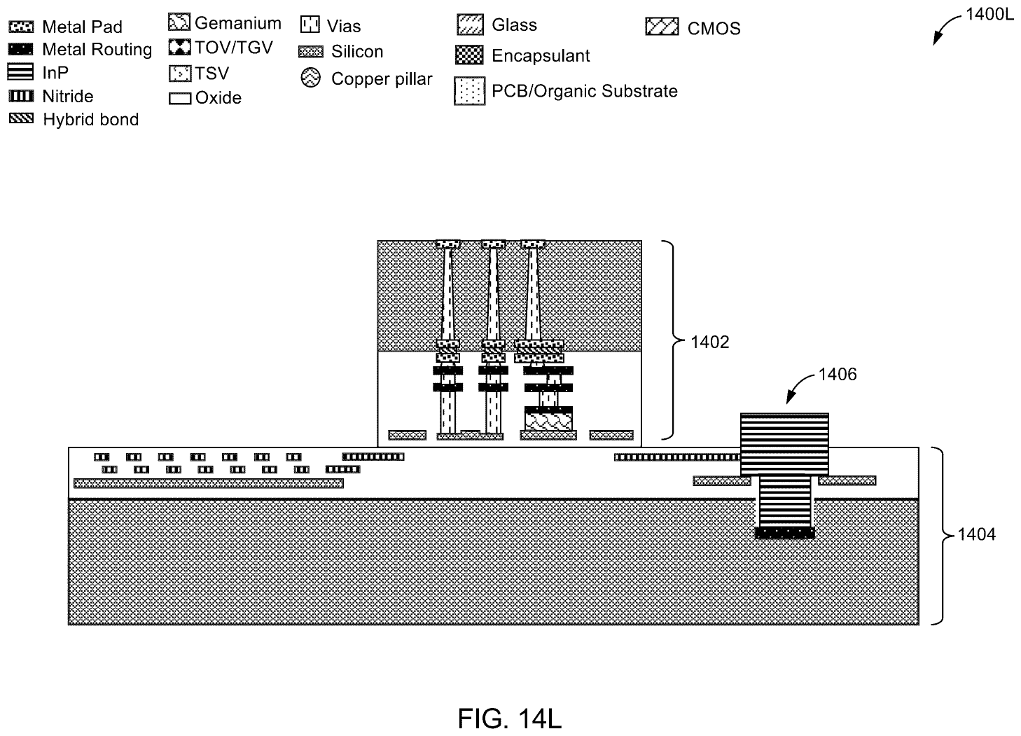

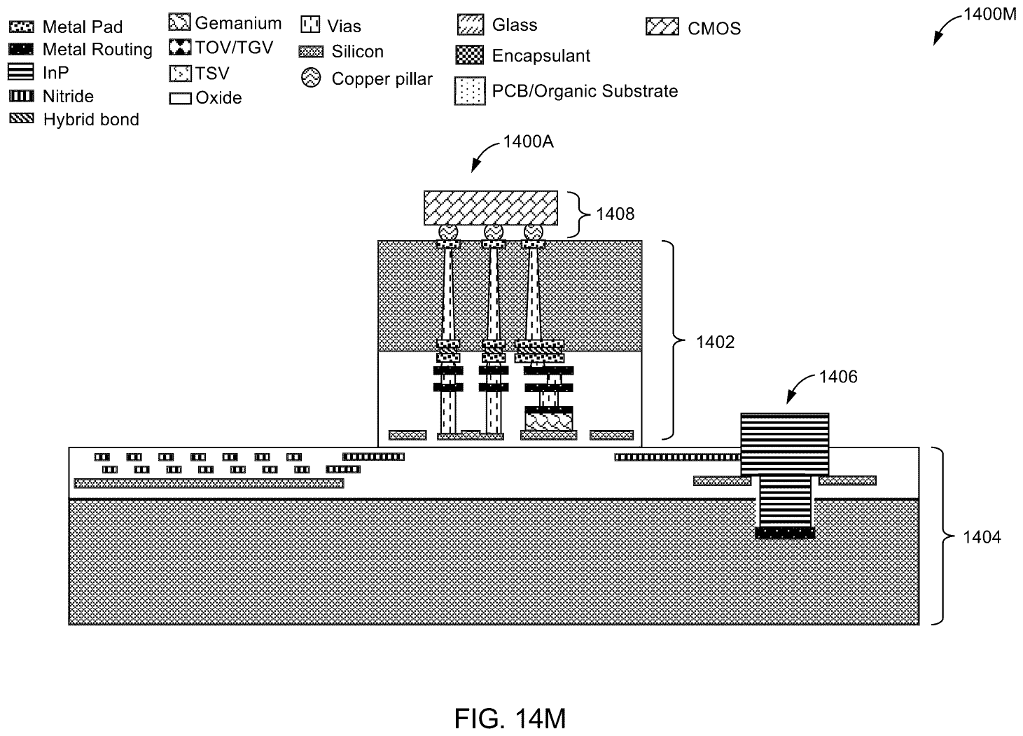

FIG. 14A shows a cross-section view of an example device 1400A comprising an active photonics chip 1402, a passive photonics chip 1404, an optical source 1406, i.e., an integrated laser or an optical amplifier, and a CMOS chiplet 1408. In this example, the CMOS chiplet 1408 includes copper pillars for flip-chip attachment to the active photonics chip 1402. The optical source 1406 is heterogeneously integrated onto the passive photonics chip 1404 and optically coupled to patterned waveguides. Optical waves are produced by the optical source and then coupled into the patterned waveguides. The optical waves 1409 from the patterned waveguides of the passive photonics chip 1404 are evanescently coupled into the active photonics chip 1402. Active components in the active photonics chip 1402, i.e., modulators or phase shifters, can interact with the optical waves. Following this interaction, optical waves 1410 are evanescently coupled back into the passive photonics chip 1404, where emission structures, i.e., grating couplers or optical antennas, emit the optical wave into free space. While the optical source 1406 can be powered by external circuitry (not shown), at least a portion of the passive photonics chip 1404 comprises passive components, such as the emission structures from which light is emitted.

As shown in FIG. 14A, optical waves 1410 are evanescently coupled from the active photonics chip 1402 into the passive photonics chip 1404 before they are emitted. In other words, the active photonics chip 1402 and the passive photonics chip 1404 are optical coupled by a first interface between a surface of the active photonics chip 1402 and a surface of the passive photonics chip 1404. These optical waves 1410 can be evanescently coupled in this first interface via a first set of two or more waveguide couplers arranged near the surface of the active photonics chip 1402 and a second set of two or more waveguide couplers arranged near the surface of the passive photonics chip 1404, such as the coupler arrays shown in FIGS. 10A-10C, FIG. 11, or FIG. 13. The optical waves 1409 are evanescently coupled from the passive photonics chip 1404 to the active photonics chip 1402. In other words, the active photonics chip 1402 and the passive photonics chip 1404 are optical coupled by a second interface between the surface of the active photonics chip 1402 and the surface of the passive photonics chip 1404. The optical waves 1409 can be evanescently coupled in this second interface via a third set of one or more waveguide couplers arranged near the surface of the active photonics chip 1402 and a fourth set of one or more waveguide couplers arranged near the surface of the passive photonics chip 1404, such as the waveguide couplers shown in FIGS. 7A-7B, FIGS. 8A-8B, or FIGS. 12A-12B. In some examples, components that are configured to transmit and couple optical waves in this manner, such as waveguides or one or more waveguide couplers of a set of waveguide couplers, can be described as being in optical communication with the optical source 1406.

In some examples, one or more optical splitters (not shown) can be included in the active photonics chip 1402 such that the optical waves 1409 that are evanescently coupled between the third set of one or more waveguide couplers and the fourth set of one or more waveguide couplers can be distributed into multiple waveguides for interaction with active components. Following interaction, the optical waves 1410 can then be evanescently coupled between the first set of two or more waveguide couplers and the second set of two or more waveguide couplers.

In some examples, one or more optical splitters (not shown) can be included in the passive photonics chip 1404 to distribute the optical waves 1409 into multiple waveguides. Following the one or more optical splitters, the optical waves 1409 can be evanescently coupled between a third set of two or more waveguide couplers and a fourth set of two or more waveguide couplers, such as the coupler arrays shown in FIGS. 10A-10C, FIG. 11, or FIG. 13.

FIGS. 14B-14M depict steps 1400B-1400M associated with assembling the components into device 1400A. During step 1400B shown in FIG. 14B, a passive photonics chip 1404 is formed from fabricated silicon-on-insulator. The passive photonics chip 1404 comprises a trench 1411 with metallization/patterned materials to facilitate integration of the optical source 1406 (not shown). The passive photonics chip 1404 further comprises patterned silicon-on-insulator and additional materials of sufficient optical transparency to facilitate routing of optical signals. Optical antennas 1412 are also included for transmitting and receiving optical signals with at least one layer close to surface of oxide capable of supporting evanescent coupling.

During step 1400C as shown in FIG. 14C, an optical source 1406 is configured. As previously mentioned, some optical sources can comprise an integrated laser or an optical amplifier. Some optical sources comprise a material that is different than a material from which a device is formed such that the optical source is heterogeneous. Some integrated lasers or optical amplifiers can comprise a laser gain material. In this example, the optical source 1406 comprises indium phosphide.

During step 1400D shown in FIG. 14D, a CMOS chiplet 1408 is configured. The CMOS chiplet 1408 comprises copper pillars such that the CMOS chiplet 1408 can be attached to the active photonics chip 1402, as shown in FIG. 14A.

An example electronic interposer chip 1414 is configured in step 1400E shown in FIG. 14E. The electronic interposer chip 1414 comprises wettable bond pads for copper pillar CMOS attach arranged on a top side of the electronic interposer chip 1414. The electronic interposer chip 1414 further comprises metal and oxide interfaces for hybrid bonding arranged on a bottom surface of the electronic interposer chip 1414. Through-silicon vias support electrical routing between the bond pads arranged on the top surface and the hybrid bonding sites arranged on the bottom surface of the electronic interposer chip 1414.

An example photonics chip 1416 is configured in step 1400F shown in FIG. 14F. The photonics chip 1416 is formed from silicon-on-insulator and comprises a thin-buried oxide to support evanescent coupling of optical waves between the photonics chip 1416 and other components (not shown). In some examples, a thin-buried oxide can comprise a thickness of <1 um to support efficient evanescent coupling of optical waves. The photonics chip 1416 further comprises a metal and oxide interface co-designed with the electronic interposer for hybrid bonding arranged on a top surface of the photonics chip 1416. In some examples, the metal and oxide interface can be formed in a back end of line process such that one or more metal layers of are deposited onto patterned wafer. In some examples, the photonics chip 1416 can comprise n- and p-type doping to enable electro-optic of thermo-optic phase shifting. One or more metal layers are also included for optical routing. The photonics chip 1416 further comprises one or more via layers to enable electrical connections between metal layers and contact layers from metal to doped silicon-on-insulator.

FIG. 14G shows step 1400G in which the electronic interposer chip 1414 and the photonics chip 1416 arranged for wafer-scale hybrid bonding. A cross-section view of the electronic interposer chip 1414 and the photonics chip 1416 following wafer-scale hybrid bonding is shown in step 1400H in FIG. 14H. Following wafer-scale hybrid bonding, the backside silicon substrate handle can be removed from the photonics chip 1416, as shown by step 1400I shown in FIG. 14I. After removal of the backside silicon substrate handle, dicing/segmentation of the hybrid bonded wafers can be performed to form one or more active photonics chips, as shown by step 1400J in FIG. 14J. FIG. 14J depicts a plurality of active photonics chips 1402, 1418, 1420 including the active photonics chip 1402 shown in FIG. 14A. Each active photonics chip 1402, 1418, 1420 comprises a portion of the electronic interposer chip 1414 and a portion of the photonics chip 1416.

FIG. 14K depicts step 1400K in which the optical source 1406 is integrated onto the passive photonics chip 1404 via the trench 1411. Following integrating, the active photonics chip 1402 can be oxide bonded to the passive photonics chip 1404, as shown by step 1400L in FIG. 14L. The CMOS chiplet 1408 can then be flip-chip attached to the active photonics chip 1402, as shown by step 1400M in FIG. 14M, to form the device 1400A.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus, comprising:
a first chip comprising a first surface in proximity to a first set of two or more waveguide couplers; and
a second chip comprising a second surface in proximity to a second set of two or more waveguide couplers;
wherein the first chip and the second chip are optically coupled to each other by an interface between the first surface and the second surface in which:
a first waveguide coupler of the first set of two or more waveguide couplers is in proximity to a second waveguide coupler of the second set of two or more waveguide couplers within a distance that supports evanescent optical coupling between the first waveguide coupler and the second waveguide coupler that are overlapped within a first coupling region,
a third waveguide coupler of the first set of two or more waveguide couplers is in proximity to a fourth waveguide coupler of the second set of two or more waveguide couplers within a distance that supports evanescent optical coupling between the third waveguide coupler and the fourth waveguide coupler that are overlapped within a second coupling region, and
the first coupling region is separated from the second coupling region by a separation distance that is larger than a maximum length of the first coupling region and larger than a maximum length of the second coupling region.

2. The apparatus of claim 1, wherein each waveguide coupler in the first set of two or more waveguide couplers is at an end of a corresponding waveguide on first chip, and each waveguide coupler in the second set of two or more waveguide couplers is at an end of a corresponding waveguide on the second chip.

3. The apparatus of claim 2, wherein the corresponding waveguides on the first chip are arranged (1) to have propagation axes that are all parallel to a common axis and (2) such that corresponding waveguide couplers of waveguides that are adjacent to each other on the first chip are offset from each other along the common axis.

4. The apparatus of claim 3, wherein the first waveguide coupler and the third waveguide coupler are substantially coplanar with a first plane that is parallel to the common axis and the second waveguide coupler and the fourth waveguide coupler are substantially coplanar with a second plane that is parallel to each of the common axis and the first plane.

5. The apparatus of claim 4, wherein
a portion of the first waveguide coupler and a portion of the second waveguide coupler within the first coupling region are contained within a third plane that is perpendicular to the first plane and perpendicular to the common axis, and
a portion of the third waveguide coupler and a portion of the fourth waveguide coupler within the second coupling region are contained within a fourth plane that is perpendicular to the first plane and perpendicular to the common axis.

6. The apparatus of claim 5, wherein the third plane and the fourth plane are distributed along the common axis.

7. The apparatus of claim 1, wherein each of the first waveguide coupler, the second waveguide coupler, the third waveguide coupler, and the fourth waveguide coupler comprise respective grating couplers.

8. The apparatus of claim 1, wherein each waveguide coupler of the first set of two or more waveguide couplers is optically coupled to a different respective optical phase shifter.

9. The apparatus of claim 1, wherein each waveguide coupler of the second set of two or more waveguide couplers is optically coupled to a different respective optical antenna.

10. The apparatus of claim 1, wherein the first surface of the first chip is in proximity to a third set of one or more waveguide couplers and the second surface of the second chip is in proximity to a fourth set of one or more waveguide couplers.

11. The apparatus of claim 10, wherein the first chip and the second chip are optically coupled to each other by a second interface between the first surface and the second surface in which:
a fifth waveguide coupler of the third set of one or more waveguide couplers is in proximity to a sixth waveguide coupler of the fourth set of one or more waveguide couplers within a distance that supports evanescent optical coupling between the fifth waveguide coupler and the sixth waveguide coupler that are overlapped within a third coupling region.

12. The apparatus of claim 11, wherein at least one waveguide coupler in the fourth set of one or more waveguide couplers is in optical communication with an optical source on the second chip.

13. An apparatus, comprising:
a first chip comprising a first surface in proximity to a first set of two or more waveguide couplers; and
a second chip comprising a second surface in proximity to a second set of two or more waveguide couplers;
wherein the first chip and the second chip are optically coupled to each other by an interface between the first surface and the second surface in which:
a first waveguide coupler of the first set of two or more waveguide couplers is in proximity to a second waveguide coupler of the second set of two or more waveguide couplers within a distance that supports evanescent optical coupling between the first waveguide coupler and the second waveguide coupler that are overlapped within a first coupling region,
a third waveguide coupler of the first set of two or more waveguide couplers is in proximity to a fourth waveguide coupler of the second set of two or more waveguide couplers within a distance that supports evanescent optical coupling between the third waveguide coupler and the fourth waveguide coupler that are overlapped within a second coupling region,
the first waveguide coupler and the third waveguide coupler are each at an end of a waveguide that is coupled to an active photonic component, and
the second waveguide coupler and the fourth waveguide coupler are each at an end of a waveguide that is coupled to a passive photonic component.

14. The apparatus of claim 13, wherein the active photonic component comprises an optical phase shifter.

15. The apparatus of claim 14, wherein the first chip comprises one or more through oxide vias in electrical communication with the active photonic component.

16. The apparatus of claim 14, wherein the passive photonic component comprises an optical antenna.

17. The apparatus of claim 13, wherein
each of the first waveguide coupler and the second waveguide coupler comprise a respective adiabatic taper within the first coupling region, and
each of the third waveguide coupler and the fourth waveguide coupler comprise a respective adiabatic taper within the second coupling region.

18. The apparatus of claim 13, wherein the first waveguide coupler comprises a first adiabatic taper and a second adiabatic taper within the first coupling region, wherein the first adiabatic taper has a first cross section and the second adiabatic taper has a second cross section that is different than the first cross section.

19. An apparatus, comprising:
a first chip comprising (1) a first surface in proximity to a first set of two or more waveguide couplers, and (2) a set of two or more optical phase shifters coupled to the first set of two or more waveguide couplers;
a second chip comprising (1) a second surface in proximity to a second set of two or more waveguide couplers, and (2) a set of two or more optical antennas coupled to the second set of two or more waveguide couplers; and
a controller to control respective phase shifts of the optical phase shifters to transmit and/or receive an optical beam using an optical phased array comprising the two or more optical antennas;
wherein the first chip and the second chip are optically coupled to each other by an interface between the first surface and the second surface in which:
a first waveguide coupler of the first set of two or more waveguide couplers is in proximity to a second waveguide coupler of the second set of two or more waveguide couplers within a distance that supports evanescent optical coupling between the first waveguide coupler and the second waveguide coupler that are overlapped within a first coupling region, and
a third waveguide coupler of the first set of two or more waveguide couplers is in proximity to a fourth waveguide coupler of the second set of two or more waveguide couplers within a distance that supports evanescent optical coupling between the third waveguide coupler and the fourth waveguide coupler that are overlapped within a second coupling region.

20. The apparatus of claim 19, wherein the second chip further comprises (3) at least one optical distribution network coupled to a third set of two or more waveguide couplers.

21. The apparatus of claim 19, wherein the first chip and the second chip are optically coupled to each other by an interface between the first surface and the second surface in which each waveguide coupler of the first set of two or more waveguide couplers is in proximity to a different respective waveguide coupler of the second set of two or more waveguide couplers within a distance that supports evanescent optical coupling between the each waveguide coupler of the first set of two or more waveguide couplers and the different respective waveguide coupler of the second set of two or more waveguide couplers within a distance that supports evanescent optical coupling between the each waveguide coupler and the different respective waveguide coupler that are overlapped within a respective coupling region.

22. The apparatus of claim 21, wherein the interface between the first surface and the second surface is configured to suppress crosstalk between adjacent coupling regions.

23. The apparatus of claim 22, wherein adjacent coupling regions are separated from each other by a separation distance that is larger than a maximum length of each of the coupling regions of the adjacent coupling regions.

24. The apparatus of claim 23, wherein each coupling region is offset from an adjacent coupling region along a respective propagation axis associated with an optical wave traveling through the coupling region.
